(19) United States
(12) Patent Application Publication
(10) Pub. No.: US 2008/0124576 A1
(43) Pub. Date: May 29, 2008

(54) POLYMER COMPOSITES

(75) Inventor: Thomas George Elliott, Warwick (GB)

Correspondence Address: NIXON PEABODY LLP - PATENT GROUP, 1100 CLINTON SQUARE, ROCHESTER, NY, 14604, US

(73) Assignee: CURON LIMITED, Warwick (GB)

(21) Appl. No.: 11/944,554

(22) Filed: Nov. 23, 2007

(30) Foreign Application Priority Data
Nov. 23, 2006 (GB) GB 0623334.0

(51) Int. Cl. B32B 9/04; B05D 3/06; B32B 37/26; C08F 290/06; B29C 71/04

(52) U.S. Cl. 428/702; 522/83; 522/81; 427/558; 156/537

(57) ABSTRACT

The present invention relates to an ultraviolet light-curable polymer resin-impregnated fibre composite sheet. In some embodiments, the composite sheet comprises polymer resins mixed with glass fibre to form polymer resin-impregnated glass fibre composites. The invention extends to methods of preparing the polymer composite, and to various applications thereof, and also to an apparatus suitable for the manufacture of the polymer composite.

This application claims the benefit of GB patent application 0623334.0 filed on Nov. 23, 2006, which is hereby incorporated by reference in its entirety.

### FIELD OF THE INVENTION

The present invention relates to polymer composites, and particularly, but not exclusively, to polymer resins mixed with glass fibre to form polymer resin-impregnated glass fibre composites. The invention extends to methods of preparing the polymer composite, and to various applications thereof, and also to an apparatus suitable for the manufacture of the polymer composite.

### BACKGROUND OF THE INVENTION

Composites formed from glass fibre reinforced plastics and/or resins are well-known, and are frequently used to form structures in situations where fire resistance, strength, rigidity, and low weight are key requirements. For example, such composites can be used in the roofing, aerospace, marine, and transport industries. These composites generally include a pre-polymer component comprising a polymer resin, glass fibre, a filler component, which acts as a bulking agent, and an initiator, which causes the pre-polymer component to polymerise, and hence solidify into the polymer composite structure, e.g., a roof covering.

Some of these glass fibre-resin composites polymerise or cure upon exposure to heat, which may be applied by an oven or heated tooling. A problem with the use of an oven to provide the heat to initiate the polymerization reaction is that it cannot be used to cure the composite in situ. Therefore, such composites are of little use in many applications in which in situ curing is a prerequisite. In some instances, the heat energy required to cure the composite may be applied by some other heat source. However, clearly there are many safety concerns with the use of various heat sources to cure the composite in situ, particularly when the composite is applied to a surface in enclosed surroundings, for example an underground train station.

Moreover, it is essential that the composite is cured evenly, to minimize the occurrence of weak spots which cause cracks. Another problem with the use of a blow torch is that is very difficult, if not impossible, to ensure that the composite is cured evenly, and so cracks tend to form. In addition, many known composites have poor fire resistance and/or are potentially toxic or harmful to the environment, for example releasing toxic emissions, such as halogens, during combustion or exposure to fire.

Yet another problem with many known composites is that the polymerization reaction is initiated by a catalyst, such as methyl ethyl ketone peroxide in combination with a cobalt accelerator. A disadvantage of using such catalysts is that there is a fixed time period following addition of the catalyst for an operator to work the material. In addition, the operator applying the catalyst can easily add too much catalyst, which results in too much heat during polymerisation, thereby causing cracking.

Accordingly, there is a significant need for new polymer resin-impregnated glass fibre composites which exhibit improved performance properties, for example fire resistance, strength, rigidity, and/or low weight, and which do not require high temperatures to cure.

Glass fibre-resin composites which polymerise or cure upon exposure to ultraviolet (UV) light instead of heat are known, and are believed to solve some of the problems suffered by heat-curable composites. UV curing composites comprise a polymer resin, glass fibre, normally a filler, and a UV photoinitiator which initiates the curing reaction. Known UV-curing composites use calcium carbonate as the filler component because it is cheap and readily available. However, a problem with the use of calcium carbonate is that it is opaque to UV light, and so the UV light is unable to easily penetrate through the composite structure. As a result, the composite cures unevenly, with the surface curing much faster than the interior, and this causes the composite to curl and distort, thereby forming weaknesses and cracks. Also, a problem with calcium carbonate as a filler is that it absorbs moisture which results in poor physical characteristics. For this reason, known UV-curing composites include very low concentrations of the filler component.

Composites with low concentrations of filler have poor strength and rigidity, and are brittle, and so cannot be used in any situation where these characteristics are important. Furthermore, known UV-curing composites suffer from high linear expansion rates, and so curl away from the substrate surface to which they are bonded. They also include high concentrations of polymer resin, which is costly.

Therefore, there is a need in the art for an improved UV-curable glass fibre-polymer resin composite, which is fast curing, which cures evenly, and which exhibits improved performance, such as fire resistance, strength, rigidity, low weight, and/or does not release toxic fumes during combustion or exposure to heat or fire.

### BRIEF DESCRIPTION OF THE DRAWINGS

For a better understanding of the invention, and to show how embodiments of the same may be carried into effect, reference will now be made, by way of example, to the accompanying diagrammatic drawings, in which:

FIG. 1 shows a schematic perspective view of a first embodiment of an apparatus for forming a composite sheet according to the present invention;

FIG. 2 shows a cross-sectional view of a composite sheet;

FIG. 3 shows a schematic perspective view of a second embodiment of an apparatus for forming a composite sheet;

FIG. 4 shows a fragmentary view, partially cut away and on an enlarged scale, of the part of the apparatus of FIG. 3 indicated by broken lines;

FIG. 5 shows a schematic side view of part of the apparatus shown in FIG. 5;

FIG. 6 shows an enlarged schematic side view of part of the apparatus shown in FIG. 5, showing fluid flow currents;

FIG. 7 is a similar view to FIG. 6; and

FIG. 8 shows a schematic perspective view of the second embodiment of an apparatus for forming a composite sheet showing additional features not shown in FIG. 3.

### DETAILED DESCRIPTION OF THE INVENTION

There have now been devised UV-curable glass fibre-reinforced composites that overcome or substantially mitigate the above-mentioned and/or other disadvantages of the prior art.

Hence, according to a first aspect of the invention, there is provided an ultraviolet light-curable polymer resin-impregnated fibre composite sheet comprising:
UV-curable polymer resin;
fibre;
at least 5% (w/w) metal hydroxide filler; and
at least one UV photoinitiator,
wherein the composite sheet becomes rigid upon exposure to UV light.

The composite sheet according to the invention is of the type often referred to as a “pre-preg”, in that it comprises a resin pre-impregnated fibre composite sheet. In contrast to typical polymer composites that are cured by the application of heat, embodiments of the present invention are “cold curing”, that is, they can cure at temperatures as low as 0° C. (and in some cases below this temperature) upon application of UV light. It will be appreciated that the rate of curing depends inter alia on the precise make-up of the composite sheet, the intensity of UV light to which the composite sheet is exposed, and also the thickness of the sheet. For instance, curing may occur faster on a sunny day than on an overcast day. However, preferably, for many applications, curing occurs within a period of less than 120 minutes, more preferably less than 100 minutes, even more preferably less than 60 minutes, and most preferably less than 30 minutes. Clearly, where the composite sheet is used in an indoor environment, which daylight is unable to reach, a portable UV light source will be required to cure the composite sheet in situ.

Surprisingly, it has been found that the use of a high concentration of metal hydroxide filler (ie at least 5% (w/w) of the total weight of the composite sheet) results in a composite material which can be used in a wide variety of applications. The particulate or powder filler may be selected to give fire resistant/retardant properties, chemical resistance and/or weather resistance to the finished product. The filler may also thicken the mixture while keeping it substantially smooth, such that the composite sheet can be stretched around corners without becoming too thin. Hence, an advantage of the composite of the invention is that it is more workable once partly cured, and can therefore be machined and drilled without causing flaking and cracks.

In addition, the filler may impart adequate physical properties on the final polymer composite, i.e., impact resistance, rigidity and strength, and abrasion resistance. Also, the composite may have a low coefficient of thermal expansion, and/or may be resistant to crack propagation and/or thermal cracking, may allow only low moisture ingress, and may be able to withstand heavy loads.

The high concentration of filler also reduces the concentration of resin in the composite sheet, thereby enabling a colder curing temperature so that differences in thermal expansion on radii and other sharp corners do not result in cracks. This is a problem when much higher concentrations of the resin are used.

Suitably, the composite sheet comprises at least 7% (w/w) filler, more suitably at least 10% (w/w) filler, and even more suitably at least 12% (w/w) filler. For some applications, the composite comprises at least 14%, 16%, 18%, 20%, 22%, 24%, 26%, 28%, 30%, 32%, 34%, 36%, 38%, or at least 40% (w/w) filler. For some applications, the composite comprises at least 42%, 44%, 46%, 48%, 50%, 52%, 54%, 56%, 58%, or at least 60% (w/w) filler.

Suitably, the weight ratio of metal hydroxide filler to polymer resin in the composite sheet is between about 0.3:1 and about 10:1, more suitably between about 0.5:1 and about 7:1, and even more suitably between about 0.7:1 and about 5:1. Preferably, the weight ratio of metal hydroxide filler to polymer resin in the composite sheet is between about 0.8:1 and about 4:1, more preferably between about 1:1 and about 3.5:1, and even more preferably between about 1.3:1 and about 3.2:1.

Preferably, the weight ratio of metal hydroxide filler to polymer resin in the composite sheet is at least about 0.5:1, preferably at least 0.7:1, preferably at least 0.9:1, preferably at least 1:1, preferably at least 1.2:1, and preferably at least 1.4:1. More preferably, the weight ratio of metal hydroxide filler to polymer resin in the composite sheet is at least about 1.5:1, preferably at least 1.8:1, preferably at least 2:1, preferably at least 2.5:1, preferably at least 2.8:1, and preferably at least 3:1.

Preferably, the metal hydroxide filler is at least partially transparent to UV light, such that UV light is capable of penetrating therethrough to cure the composite. It will be appreciated that UV light has a wavelength of between about 200 nm and about 400 nm, with UV-A having a wavelength between 320 nm and 400 nm, UV-B having a wavelength of between 280 nm and 320 nm, and UV-C having a wavelength of below 280 nm. It is therefore preferred that the metal hydroxide filler, and hence the composite sheet according to the first aspect transmits UV-A, UV-B, and UV-C, to enable curing to occur.

The metal hydroxide may comprise a suitable Group 3 metal hydroxide. Preferably, the metal hydroxide comprises aluminium hydroxide. The metal hydroxide may comprise a metal dihydroxide or metal trihydroxide. Most preferably, the metal hydroxide comprises aluminium trihydroxide, i.e., Al(OH)₃. Aluminium hydroxide mixes well with polymer resin and reduces “white spots” and subsequent weakening of the sheet. White spots are areas of filler that are not fully dissolved in the resin.

The metal hydroxide may be provided in different particle sizes. It will be appreciated that materials, such as the filler, will have a particle size distribution characterized by a mean particle size. Preferably, the filler has a mean particle size of between about 1 μm and about 50 μm, more preferably between about 2 μm and about 40 μm, and most preferably between about 3 μm and about 30 μm.

The metal hydroxide may be provided in fine particle size and/or medium particle size.

The filler may have a mean particle size of between about 500 nm and about 10 μm, more preferably between about 1 μm and about 7 μm, and most preferably between about 3 μm and about 5 μm. Alternatively, the filler may have a mean particle size of between about 5 μm and about 50 μm, more preferably between about 10 μm and about 25 μm, and most preferably between about 12 μm and about 17 μm.

As mentioned previously, aluminium hydroxide mixes well with the polymer resin and reduces “white spots” and subsequent weakening of the sheet. White spots are areas of filler that are not fully dissolved in the resin, and although the inventor does not wish to be bound by any hypothesis, he believes that the reduction in ‘white spots’ may be due to the fine particle size of the ATH.

Preferably, the bulk density of the filler is between about 1.5 g/cm³ and about 5 g/cm³, more preferably between about 2.0 g/cm³ and about 3.0 g/cm³, and most preferably between about 2.2 g/cm³ and about 2.8 g/cm³.

The metal hydroxide filler may be obtained from Omya UK Ltd, UK. Currently, most preferred metal hydroxide fillers are those grades of aluminium trihydroxide sold under the trade names Omya Martinal ON 904 (fine particle size) and Omya Martinal ON 921 (medium particle size). Omya Martinal ON 904 has a median particle size of about 4 μm, and Omya Martinal ON 921 has a median particle size of about 21 μm.

The polymer resin present in the composite sheet sets or cures or polymerizes upon exposure to UV light, thereby solidifying, and encapsulating the glass fibre component of the composite sheet.

The polymer resin may comprise an epoxy resin or an epoxy vinyl resin. Preferably, the polymer resin comprises an ester resin, and most preferably a vinyl ester resin or a polyester resin. Most preferably, the polyester resin is unsaturated. One preferred resin is unsaturated polyester resin, for example that sold under the trade name Synolite® P17-02 or Synolite® 5001-T-1, which may be obtained from DSM Composite Resins, The Netherlands. Synolite® 5001-T-1 is a thixotropic, non-halogenated, non-pre-accelerated unsaturated polyester resin.

Another suitable resin comprises an isophthalic acid/neopentyl glycol-based unsaturated polyester resin.

Preferred polyester resins which may be obtained from Scott Bader Company Limited, UK are those sold under the trade names Crystic PD6635UV and Crystic PD9635UV, which comprise approximately 50 to 55% (w/w) unsaturated polyester resin in about 40 to 45% (w/w) styrene. Furthermore, such polymer resins comprise a photoinitiator, phenylbis(2,4,6-trimethylbenzoyl)-phosphine oxide. Hence, where such polymer resins are used, it may be unnecessary for the composite sheet to include additional UV photoinitiator.

In another embodiment, a preferred polyester resin is Palapreg P17-02 or Palapreg P 15-01, which may be obtained from DSM Composite Resins, The Netherlands. Palapreg P1702 is an unsaturated polyester resin derived from orthophthalic acid and standard glycols, dissolved in styrene. It comprises approximately 50 to 55% (w/w) unsaturated polyester resin in about 40 to 45% (w/w) styrene. Palapreg P1702 does not comprise any UV photoinitiator. Palapreg P 15-01 is an unsaturated polyester resin derived from isophthalic acid and standard glycols, dissolved in styrene.

Another preferred vinyl ester resin, which may be obtained from DSM Composite Resins, The Netherlands, may be any of these sold under the trade name Atalac 590, or Atalac 382, or Atalac E-Nova FW 2045. Atalac 590 is an epoxy novolac-based vinyl ester, dissolved in styrene. Atalac 382 is propoxylated bisphenol A fumarate unsaturated polyester resin, dissolved in styrene. Atalac E-Nova FW 2045 is a modified epoxy bisphenol A vinyl ester urethane resin, dissolved in styrene. In another embodiment, a preferred resin comprises Resin Euro 5001.

Preferably, the polymer resin comprises polymeric material dispersed in a reactive solvent, e.g., styrene.

Preferably, the composite sheet comprises at least 15% (w/w) polymer resin, more suitably at least 18% (w/w) resin, and even more suitably at least 20% (w/w) resin. The composite preferably comprises at least 25%, 30%, 35%, 40%, or at least 45% (w/w) polymer resin.

The fibre is present in the composite sheet in order to provide reinforcement to the product, and in particular to improve its tensile strength. The fibre component of the composite sheet may comprise carbon fibres, graphite fibres, polymeric fibres, boron filaments, ceramic fibres, metal fibres, asbestos fibres, beryllium fibres, silica fibres, or silicon carbide fibres.

However, preferably the fibre comprises glass fibre. The glass fibre may be used in the form of loose fibres, mixed in with the polymer resin, but is preferably provided in sheet form (such as chopped strand mat, or woven roving) with the resin being spread onto the sheet, or sprayed or painted or applied by way of dipping the sheet into the composition, or passing the sheet through a system of rollers provided with a dispenser for applying the resin thereto.

Preferably, the glass fibre is in the form of a sheet or mat, such as chopped strand mat (CSM). One or more sheets of glass fibre may be used. Where at least two sheets are used, they may be the same or different.

A preferred chopped strand mat may be that which is available under the trade name CSM 92, which may be obtained from PPG Industries Inc, USA. CSM 92 is a general purpose emulsion-bound chopped strand mat. A preferred glass fibre may be that which is available under the trade name PPG Sinoma MAT92 Emulsion-bound chopped strand mat 300 g per square metre, which may be obtained from Polyfibre UK, Birmingham, UK.

The weight of the fibre may be varied depending on the intended use of the composite sheet. For example, the sheet may comprise at least 100 g/m² of fibre, or at least 200 g/m² of fibre, preferably glass fibre. Preferably, the sheet comprises at least 300 g/m² of glass fibre, more preferably at least 400 g/m², even more preferably at least 600 g/m², and most preferably at least goo g/m² of glass fibre. Hence, in one embodiment, a preferred sheet comprises 300 g/m² of glass chopped strand mat (CSM). In another embodiment, the sheet comprises woven roving or some other suitably bound glass fibre matting known to the skilled technician. In yet another embodiment, two or more fibre sheets may be used. The two or more sheets may be the same or different. For example, the composite sheet may comprise two sheets of 300 g/m² or one of 300 g/m² and one of 45 g/m². A preferred woven roving is that which is supplied under the trade name Tyglas, which may be obtained from Fothergill Engineered Fabrics Ltd, UK. Woven roving is a woven glass fibre textile bound by the weave.

Suitably, the composite sheet comprises at least 10% (w/w) fibre, more suitably at least 15% (w/w) fibre, and even more suitably at least 18% (w/w) fibre. The composite preferably comprises at least 20%, 22%, or at least 24% (w/w) fibre.

Suitably, the weight ratio of fibre to polymer resin in the composite sheet is between about 0.2:1 and about 3:1, more suitably between about 0.4:1 and about 2:1, and even more suitably between about 0.5:1 and about 1.5:1. Preferably, the weight ratio of fibre to polymer resin in the composite sheet is between about 0.6:1 and about 1.4:1, more preferably, between about 0.7:1 and about 1.3:1, and even more preferably between about 0.8:1 and about 1.2:1.

Preferably, the weight ratio of fibre to polymer resin in the composite sheet is at least about 0.2:1, preferably at least 0.4:1, preferably at least 0.5:1, preferably at least 0.6:1, preferably at least 0.7:1, and more preferably at least 1:1. More preferably, the weight ratio of fibre to polymer resin in the composite sheet is at least about 1.1:1, and preferably at least 1.2:1.

The photoinitiator is provided in the composite sheet in order to initiate the curing reaction by which the polymer resin polymerises.

Photoinitiators are well known in the art, and it will be appreciated that the composite sheet according to the invention is not limited to any specific photoinitiator. Indeed, the composite sheet according to the invention may comprise one or more photoinitiators. The photoinitiator may be of either the cleavage or hydrogen abstraction type. The photoinitiator is preferably selected from a group of photoinitiator classes consisting of benzophenones, thioxanthones, hydroxyalkylphenones, aminoalkylphenones, anthraquinones, acyl phosphine oxides, bis-acyl phosphine oxides, benzyl ketals, benzoin ethers, acetophenones, beta ketosulphones, oxime esters and phenyl glyoxic acid esters.

Further examples of suitable photoinitiators may be found in Ciba's Irgacure and Darocure ranges, for example, Irgacure 184 (1-hydroxy-cyclohexyl-phenyl-ketone), Irgacure 651 (2,2-dimethoxy-1,2-diphenylethan-1-one), Irgacure 819 (Bis(2,4,6-trimethylbenzoyl)-phenylphosphineoxide and Darocur TPO (2,4,6-trimethylbenzoyl-diphenyl-phosphineoxide). The UV photoinitiator may comprise methyl ethyl ketone peroxide (MEKP), which promotes the curing reaction in pre-determined conditions. In general, a single photoinitiator or a blend of several photoinitiators may be used, with or without an amine synergist, to achieve the desired balance of product properties.

The photoinitiator may also be selected from the group consisting of Ciba Geigy Irgacure 819, Ciba Geigy Irgacure 184 (1-hydroxy cyclohexyl phenyl ketone), Ciba Geigy Irgacure 654 (benzildimethyl ketal), Ciba Geigy Irgacure 907 (2-methyl-1-{4(methylthio)phenyl}-2-morpholino-propanone-1), Merck Darocur 1664, Rohm Catalyst 22, Alcolac Vicure 10 (isobutyl benzoin ether), Alcolac Vicure 30 (isobutyl benzoin ether), and Alcolac Vicure 55 (55) (methyl phenyl glyoxylate phenyl ketone).

Preferably, the composite sheet comprises between about 0.01 and about 3% (w/w) photoinitiator, more preferably between about 0.03 and about 2% (w/w) photoinitiator, even more preferably between about 0.04 and about 1% (w/w) photoinitiator, and most preferably between about 0.06 and about 0.9% (w/w) photoinitiator.

Preferably, the weight ratio of photoinitiator to polymer resin in the composite sheet is at least about 1:1000, preferably at least 2:1000, preferably at least 3:1000, preferably at least 4:1000, preferably at least 5:1000, and more preferably at least 10:1000. More preferably, the weight ratio of photoinitiator to polymer resin in the composite sheet is at least about 15:1000, and preferably at least 20:1000.

The UV photoinitiator may comprise phenylbis(2,4,6-trimethylbenzoyl)-phosphine oxide. In some embodiments, the UV photoinitiator may be supplied premixed with the polymer resin. Alternatively, the UV photoinitiator may be added separately to the mixture of components used in the manufacture of the composite sheet.

The UV photoinitiator may be supplied under the trade name Chivacure (eg Chivacure 107), which may be obtained from Campbell & Co, USA. Chivacure 107 comprises 2-methyl-4′-(methylthio)-2-morpholinopropiophenone. Preferably, the composite sheet comprises between about 0.01 and about 1% (w/w) Chivacure, more preferably between about 0.03 and about 0.5% (w/w) Chivacure, even more preferably between about 0.04 and about 0.2% (w/w) Chivacure, and most preferably between about 0.06 and about 0.1% (w/w) Chivacure.

The UV photoinitiator may be that supplied under the trade name Catalyst Trigonal 15, which may be obtained from Akzo Nobel Polymer Chemicals by, The Netherlands. Trigonal 15 is a benzoin butyl ether formulation. Preferably, the composite sheet comprises between about 0.1 and about 2% (w/w) Catalyst Trigonal 15, more preferably between about 0.2 and about 1% (w/w) Catalyst Trigonal 15, even more preferably between about 0.3 and about 0.9% (w/w) Catalyst Trigonal 15, and most preferably between about 0.4 and about 0.8% (w/w) Catalyst Trigonal 15.

In addition to the UV-curable resin, the fibre, the metal hydroxide filler and the photoinitiator, the composite sheet according to the invention may comprise one or more additives which are included to achieve the appropriate physical and chemical properties for any given application.

Preferably, the composite sheet comprises a maturation agent, which is capable of increasing the viscosity of the composition. It will be appreciated that increasing the viscosity of the composition causes it to thicken so that the resultant composite sheet becomes tacky. Furthermore, increasing the viscosity makes it resistant to slumping, and sufficiently stiff to handle prior to exposure to UV light. Furthermore, the maturation agent enables the composite sheet to be stored in rolls and thereby does not limit storage to horizontal sheets. Advantageously, composites comprising a maturation agent do not require any pre-curing prior to being moulded or applied to a substrate surface.

The skilled technician will appreciate that the viscosity and hence “tackiness” of the composition may be defined by poise number (P, where 1P equates to 1 g/cm/s or 1 Pa·s). Hence, the maturation agent may be capable of increasing the viscosity of the composition from about 100 Pa·s to at least 100 Pa·s, and more preferably at least 1,000,000 Pa·s, and most preferably, at least 2,000,000 Pa·s.

The maturation agent may comprise silica, such as amorphous fumed silica from Wacker-Chemie, Germany. The maturation agent may comprise elemental magnesium, preferably in powder form. However, a preferred maturation agent comprises a suitable metal oxide. The metal oxide may comprise a suitable alkali or alkaline earth metal oxide. Preferably, the metal oxide comprises magnesium oxide (MgO). The maturation agent may comprise the grade of magnesium oxide sold under the trade name Luvatol® MK 35 Liquid, which may be obtained from Lehmann and Voss, Germany.

However, a preferred maturation agent is that sold under the trade name Garolite DE, which may be obtained from Omya UK Ltd, UK. Garolite DE comprises MgO (about 99% w/w), and has a flame retardance factor of 144 m²/g, and has a fine residue of about 0.5% on a 200 μm mesh, and a specific surface area BET of about 160 m²/g.

The inventor has found that the composite sheet needs to be sufficiently sticky/tacky so that it can be adhered to a substrate surface, for example a roof. However, if too much maturation agent is added, the composite sheet loses tackiness and may become less workable and unformable. Hence, in embodiments where a maturation is used, it is important that sufficient but not too much maturation agent should be added to the composite sheet.

Therefore, where a maturation agent is used, the composite sheet preferably comprises between about 0.05 and about 2% (w/w) maturation agent, more preferably between about 0.1 and about 1% (w/w) maturation agent, even more preferably between about 0.15 and about 0.5% (w/w) maturation agent, and most preferably between about 0.17 and about 0.25% (w/w) maturation agent.

Preferably, the weight ratio of maturation agent to polymer resin in the composite sheet is at least about 1:1000, preferably at least 2:1000, preferably at least 3:1000, preferably at least 4:1000, preferably at least 5:1000, and more preferably at least 6:1000. More preferably, the weight ratio of maturation agent to polymer resin in the composite sheet is less than about 20:1000, and preferably less than about 10:1000.

In some embodiments, for example when using less reaction polymer resins, the concentration of maturation agent must be increased. Hence, the weight ratio of maturation agent to polymer resin in the composite sheet may be at least about 1:100, preferably at least 2:100, preferably at least 3:100, preferably at least 4:100, preferably at least 5:100, and more preferably at least 6:100. More preferably, the weight ratio of maturation agent to polymer resin in the composite sheet is less than about 20:100, and preferably less than about 10:1000. In preferred embodiments, the weight ratio of maturation agent to polymer resin in the composite sheet may be between about 7:100 and about 10:100.

The composite sheet may comprise a wetting agent, which is capable of wetting and dispersing the components of the sheet, and in particular facilitates the mixing of the filler with the polymer resin.

Examples of suitable wetting agents are those sold under the trade names BYK-W 996, BYK-W 995, BYK-W 9010, and BYK-990, which are supplied by BYK-Chemie GmbH, Germany.

Where a wetting agent is used, the composite sheet preferably comprises between about 0.1 and about 4% (w/w) wetting agent, more preferably between about 0.2 and about 2% (w/w) wetting agent, even more preferably between about 0.25 and about 1.2% (w/w) wetting agent, and most preferably between about 0.4 and about 1% (w/w) wetting agent.

Preferably, the weight ratio of wetting agent to polymer resin in the composite sheet is at least about 1:1000, preferably at least 5:1000, preferably at least 10:1000, preferably at least 15:1000, preferably at least 20:1000, and more preferably at least 25:1000. More preferably, the weight ratio of wetting agent to polymer resin in the composite sheet is at least 35:1000, and preferably at least 40:1000.

In addition to the reactive solvent that may be present as a component of the UV-curable resin, the composite sheet may comprise an additional reactive solvent, which may modify the viscosity of the composition and facilitate mixing of the resin mix with the fibre, as well participating in the curing reaction. A suitable reactive solvent may be styrene or acetone.

Where such a reactive solvent is present as a separate component from the UV-curable resin, the composite sheet preferably comprises between about 0.2 and about 4% (w/w) reactive solvent, more preferably between about 0.5 and about 3% (w/w) reactive solvent, even more preferably between about 0.75 and about 1.5% (w/w) reactive solvent, and most preferably between about 0.9 and about 1.3% (w/w) reactive solvent.

Preferably, the weight ratio of the reactive solvent to polymer resin in the composite sheet is at least about 5:1000, preferably at least 10:1000, preferably at least 15:1000, preferably at least 20:1000, preferably at least 25:1000, and more preferably at least 30:1000. More preferably, the weight ratio of the styrene to polymer resin in the composite sheet is at least 35:1000, and preferably at least 40:1000.

Known UV-curing compositions generally contain little or no colouring agent or pigment. This is because in known compositions, the pigment has a negative effect on the curing reaction as it blocks the UV light.

Preferably, the composite sheet according to the invention comprises pigment, which adds colour to the product. The specific choice of polymer resin and photoinitiator enable a strong pigment to be used without degrading or impeding the curing reaction. Any suitable pigment may be used, for example, colour paste as supplied by Llewellyn Ryland, UK. Preferred pigments comprise a polyester-based colour paste.

Where pigment is used, the composite sheet preferably comprises between about 0.01 and about 2% (w/w) pigment, more preferably between about 0.05 and about 1% (w/w) pigment, even more preferably between about 0.1 and about 0.8% (w/w) pigment, and most preferably between about 0.15 and about 0.6% (w/w) pigment.

Preferably, the weight ratio of the pigment to polymer resin in the composite sheet is at least about 1:1000, preferably at least 2:1000, preferably at least 3:1000, preferably at least 4:1000, preferably at least 5:1000, and more preferably at least 6:1000. More preferably, the weight ratio of the pigment to polymer resin in the composite sheet is at least 7:1000, and preferably at least 10:1000.

Advantageously, due to the specific ingredients of the composite sheet, much higher concentrations of pigment may be used compared to the prior art.

The composite sheet may comprise an agent capable of accelerating the rate of the curing reaction upon exposure to UV light. The skilled technician will appreciate that there are many chemicals which may be used to accelerate or catalyse the curing reaction. One example of a suitable accelerating agent may comprise cobalt, for example as supplied by Akzo Chemie, Germany.

A preferred accelerating agent may be Methyldiethanolamine (MDEA), which may be obtained from Hunstman Holland BV, The Netherlands. MDEA comprises approximately 60-100% (w/w) of monomethyldiethanolamine.

Where an accelerating agent is used, the composite sheet preferably comprises between about 0.1 and about 2% (w/w) accelerating agent, more preferably between about 0.2 and about 1% (w/w) accelerating agent, even more preferably between about 0.3 and about 0.8% (w/w) accelerating agent, and most preferably between about 0.4 and about 0.75% (w/w) accelerating agent.

Preferably, the weight ratio of the accelerating agent to polymer resin in the composite sheet is at least about 1:1000, preferably at least 5:1000, preferably at least 10:1000, preferably at least 15:1000, preferably at least 17:1000, and more preferably at least 20:1000. More preferably, the weight ratio of the accelerating agent to polymer resin in the composite sheet is less than 50:1000, and preferably less than 30:1000.

The composite sheet may comprise a fire or flame retardant agent, capable of preventing, inhibiting or slowing down the rate of fire, flames or smoke. The fire retardant agent is preferably intumescent, i.e., it swells as a result of heat exposure, thus increasing its volume, and decreasing in density.

Where a fire retardant agent is present, the composite sheet preferably comprises between about 1 and about 60% (w/w) fire retardant agent, more preferably between about 10 and about 40% (w/w) fire retardant agent, even more preferably between about 15 and about 30% (w/w) fire retardant agent, and most preferably between about 20 and about 25% (w/w) fire retardant agent.

Preferably, the weight ratio of fire retardant agent to polymer resin in the composite sheet is at least about 0.5:1, preferably at least 0.75:1, preferably at 1:1, and more preferably at least 1.25:1. It is especially preferred that the weight ratio of fire retardant agent to polymer resin in the composite sheet is at least about 1.5:1, preferably at least 2:1, preferably at 2.5:1, and most preferably at least 3:1.

One example of a preferred fire retardant agent is sold under the trade name Guardion 457X, which may be obtained from Chance & Hunt Ltd, UK. Another preferred fire retardant agent may be selected from those agents sold under the trade names Ceepree C200, C200M, C600, C600M, or CH4, each of which may be obtained from Chance & Hunt Ltd, UK. A most preferred fire retardant agent is Ceepree CH2.

The composite sheet may comprise one or more additional fillers, e.g., glass beads or glass hollow spheres, in order to provide strength and bulk up the composition of the sheet at lower cost.

The glass beads may have various dimensions. However, it is preferred that the median diameter of each glass bead may be between about 1 and 200 μm, more preferably between about 2 and 100 μm, even more preferably between about 5 and 50 μm, and most preferably between about 10 and 30 μm.

Examples of suitable glass beads include those sold under the trade name Potters Spheriglass grades 2530, 2000, 3000, 5000, 7000, which are available from Potters Europe, UK.

Where glass beads are used, the composite sheet preferably comprises between about 1 and about 40% (w/w) glass beads, more preferably between about 5 and about 30% (w/w) glass beads, even more preferably between about 7 and about 25% (w/w) glass beads, and most preferably between about 10 and about 20% (w/w) glass beads.

The glass hollow spheres may also have various dimensions. However, it is preferred that the median diameter of each glass hollow sphere may be between about 1 and 200 μm, more preferably between about 20 and 150 μm, even more preferably between about 40 and 100 μm, and most preferably between about 55 and 85 μm.

Examples of suitable glass hollow spheres include those sold under the trade name Q-CEL Hollow Spheres, which are available from OMYA, UK.

Where glass beads are used, the composite sheet preferably comprises between about 1 and about 40% (w/w) glass beads, more preferably between about 5 and about 30% (w/w) glass beads, even more preferably between about 7 and about 25% (w/w) glass beads, and most preferably between about 10 and about 20% (w/w) glass beads.

The composite sheet may comprise an agent for releasing the number and size of air bubbles therein, or at least from the polymer resin. A suitable air releasing agent may be that sold under the trade name Byk-A 500,501,515, 550,555 or 560, which are available from BYK Chemie, Germany.

In particularly preferred embodiments of the composite sheet, the uncured composite is sandwiched between two release films, which are capable of preventing migration of the polymer resin, and in particular the solvent (eg styrene). The release films allow the composite to be formed as a sheet and wound onto a roll for transport, and then easily unrolled for use. The release films are adapted to be removed from the composite sheet prior to application to a substrate surface. The release films may comprise a polymer sheet, nylon or polyester (such as Melinex) or the like. An example of a suitable release film comprises PET (polyethylene terephthalate). However, a preferred release film may comprise Trennfilm C or Release Film P, which may be obtained from MF-Folien GmbH, Germany. These release films comprise cast nylon film PA6 interleaving film made of modified polyamide 6.

The release films may both be polymer release films (for example polyethylene terephthalate (PET)), or one may be a polymer film and the other may be a paper or other release film.

The composite sheet may further comprise at least one film, which may be printed or coloured so as to give a product with particular aesthetic characteristics (eg a wood grain effect). Such a printed or coloured film, which may be polymer- or paper-based, may be used instead of one of the release films, or may be applied over one of the release films.

It is desirable for the composite sheet according to the invention to thicken sufficiently so as not to slump or seep, particularly when on a roll, but not so much that the composite becomes rigid prior to curing, i.e., prior to exposure to UV light. Furthermore, because the composite sheet is cured by UV, it is especially preferred that it is shielded from UV light prior to use, and during transport and storage. Hence, preferably the composite sheet comprises at least one outer layer which is substantially opaque to UV light. Hence, when the composite sheet is on a roll, it is preferred that the outer layer is disposed on the outer side of the roll to thereby shield the composite sheet from UV light, and hence prevent unwanted curing from UV light present in daylight or direct sunlight. Most preferably, the outer layer is capable of reflecting light, and so may have a reflective surface, such as metal or silver foil. Preferably, the outer layer is removed prior to application to the substrate surface. Alternatively, or in addition, sheets or rolls of the composite sheet may be overwrapped with opaque packaging material, e.g., an opaque plastics wrapper, or may be packaged in sealed and opaque containers, e.g., plastics or cardboard boxes or tubes.

Sheets comprising the polymer composite of the present invention, with optional release films, are suitable for many applications. For example, they can be used in marine construction (eg manufacture of boat and yacht decks, or hulls, or internal furnishing such as shower trays or baths etc), in commercial and domestic buildings (eg roofing, shower trays, baths, shower enclosures, bunds), in transport applications (eg panels, train decks, train nose cones, train seats, baggage storage containers, cladding), in aviation applications (aircraft wings, engine components, internal ducts, spar packers or fuselage) and many others.

Therefore, in a second aspect there is provided the use of a composite sheet according to the first aspect for preparing a UV-cured article.

Furthermore, in a third aspect, there is provided a method of forming a UV-cured article, the method comprising the steps of:
(i) exposing a composite sheet according to the first aspect to UV light; and
(ii) allowing the composite sheet to become rigid to thereby form a UV cured article.

Preferably, the method comprises an initial step (ie before step (i)) of contacting the composite sheet according to the first aspect with a suitable substrate surface on which the sheet is cured with UV light to form the UV-cured article. The substrate surface may be the surface of a mould, for example a mould for a boat hull, or any surface which requires the application of the composite sheet thereto, for example a roof. Once the composite sheet is in position on the substrate surface, step (i) may be carried out to expose it to UV to initiate the curing reaction. The UV light may be from sunlight or from some other UV source, e.g., a handheld UV emitter. The time of exposure to UV required by step (ii) will depend on various factors, including the intensity of the UV source. If daylight is used to provide the UV, and it is strong sunlight, then curing may be complete within a matter of minutes. However, long periods may be required if the UV source is weak, or if the composite sheet is particularly thick. In embodiments where the substrate surface is a mould, the method will normally comprise the further step of releasing the cured article from the mould. However, in some embodiments (for example where no mould is required), the cured article remains in position on the substrate surface.

In preferred embodiments of the method of the third aspect, in which the composite sheet is to be bonded to the substrate, the composite sheet according to the first aspect may be used in combination with a primer composition. The primer composition is preferably initially applied to the substrate surface before application of the composite sheet. The primer composition seals the substrate surface and improves adhesion of the composite sheet thereto. The primer preferably comprises polymer resin, which may comprise an epoxy resin or an epoxy vinyl resin. Preferably, the polymer resin comprises an ester resin, and most preferably a vinyl ester resin or a polyester resin. Most preferably, the polyester resin is unsaturated. Preferably, the primer comprises a UV photoinitiator. Preferably, the polymer resin used in the primer is chemically compatible, similar or identical to that used in the composite sheet applied thereto.

Once the primer composition has been applied to the substrate surface, the composite sheet according to the first aspect is then applied thereto, preferably prior to full cure of the primer being achieved. In cases where the primer is applied where no UV is present, it is desirable that the primer is partially cured prior to adhering the composite sheet, particularly if the substrate is not transparent.

The composite sheet according to the first aspect may also be used in combination with a topcoat composition. The topcoat composition will generally be a polymeric resin that is chemically compatible with the composite sheet to which it is applied. In preferred embodiments, the polymeric resin used in the topcoat composition is similar or identical to that in the composite sheet. The topcoat composition covers any imperfections such as pinholes that may appear in the surface of the composite sheet, making a final waterproofing layer.

Hence, the topcoat composition preferably comprises a UV-curable polymer resin; at least 5% (w/w) metal hydroxide filler; and at least one UV photoinitiator, and becomes rigid upon exposure to UV light.

The polymer resin in the topcoat composition may comprise an epoxy resin or an epoxy vinyl resin. Preferably, the polymer resin comprises an ester resin, and most preferably a vinyl ester resin or a polyester resin. Most preferably, the polyester resin is unsaturated. Preferably, the primer comprises a UV photoinitiator. Preferably, the polymer resin used in the topcoat composition is chemically compatible, similar or identical to that used in the composite sheet to which it is applied.

Preferably, the topcoat composition comprises at least 15% (w/w) polymer resin, more suitably at least 18% (w/w) resin, and even more suitably at least 20% (w/w). The topcoat composition preferably comprises at least 25%, 30%, 35%, 40%, or at least 45% (w/w) polymer resin. Preferably, the polymer resin comprises polymeric material dispersed in a reactive solvent, e.g., styrene.

Suitably, the topcoat composition comprises at least 7% (w/w) filler, more suitably at least 10% (w/w) filler, and even more suitably at least 12% (w/w) filler. For some applications, the topcoat composition comprises at least 14%, 16%, 18%, 20%, 22%, 24%, 26%, 28%, 30%, 32%, 34%, 36%, 38%, 40% or at least 42% (w/w) filler.

Suitably, the weight ratio of metal hydroxide filler to polymer resin in the topcoat composition is between about 0.3:1 and about 7:1, more suitably between about 0.4:1 and about 5:1, and even more suitably between about 0.5:1 and about 4:1. Preferably, the weight ratio of metal hydroxide filler to polymer resin in the topcoat composition is between about 0.6:1 and about 3:1, more preferably between about 0.7:1 and about 2:1.

Preferably, the weight ratio of metal hydroxide filler to polymer resin in the topcoat composition is at least about 0.3:1, preferably at least 0.4:1, preferably at least 0.5:1, preferably at least 0.6:1, preferably at least 0.7:1, and preferably at least 0.8:1. More preferably, the weight ratio of metal hydroxide filler to polymer resin in the topcoat composition is at least about 0.9:1, and preferably at least 1:1.

The topcoat composition may comprise glass particles or flakes or fibres. Glass fibres may be between about 5 mm and 10 mm in length, and of the type called milled fibres.

For example, the glass flakes may be those supplied under the trade name Microglas® Glass Flake, supplied by NGF Europe Limited, UK. The dimensions of the glass flakes may vary. For example, a most preferred glass flake is Microglas® Glass Flake RCF-600, at least 80% of which comprises 150 μm 1700 μm flake size, and no more than 20% of which comprises less than 150 μm flake size.

Where glass is present in the topcoat, the topcoat composition preferably comprises between about 1 and about 10% (w/w) glass flakes, more preferably between about 2 and about 8% (w/w) glass flakes, even more preferably between about 4 and about 7% (w/w) glass flakes, and most preferably between about 5 and about 7% (w/w) glass flakes.

Preferably, the weight ratio of glass flakes to polymer resin in the topcoat composition is at least about 0.01:1, preferably at least 0.02:1, preferably at least 0.03:1, preferably at least 0.05:1, preferably at least 0.1:1, and more preferably at least 0.15:1.

The topcoat composition may comprise a thixotropic agent, which is capable of modulating the rheology and hence viscosity of the composition. Furthermore, the inventor has found that the thixotropic agent is capable of keeping the glass flakes in suspension in the topcoat composition.

The skilled technician will appreciate that there are numerous thixotropic agents on the market which would have the desired function in the topcoat composition. One example of a suitable thixotropic agent is that sold under the trade name BYK-410, which may be obtained from BYK Chemie, Abelstrasse 45, 46483, Wesel, Germany. BYK-410 comprises a solution of modified urea, N-methyl-2-pyrrolidone (30-50% w/w), and lithium chloride (1-3% w/w).

Where a thixotropic agent is present, the topcoat composition preferably comprises between about 0.1 and about 2% (w/w) thixotropic agent, more preferably between about 0.2 and about 1% (w/w) thixotropic agent, even more preferably between about 0.25 and about 0.9% (w/w) thixotropic agent, and most preferably between about 0.22 and about 0.85% (w/w) thixotropic agent.

Preferably, the weight ratio of the thixotropic agent to polymer resin in the topcoat composition is at least about 5:1000, preferably at least 10:1000, preferably at least 15:1000, preferably at least 20:1000, preferably at least 25:1000, and more preferably at least 30:1000. More preferably, the weight ratio of the thixotropic agent to polymer resin in the composite sheet is at least 35:1000, and preferably at least 40:1000.

The topcoat composition may comprise a wax, which is capable of giving the sheet a substantially smooth finish and improve weatherability. The wax acts as an anti-tack additive, which is capable of reducing the tackiness of the composition.

One example of a suitable wax is sold under the trade name BYK-S 780, supplied by BYK-Chemie GmbH, Germany. Another preferred wax is Solution MW, which may be obtained from Scott Bader Company Limited, UK. Solution MW comprises about 20-25% (w/w) naphtha (petroleum) hydrodesulfurised heavy, and about 65-70% styrene, which acts as reactive solvent.

Preferably, the topcoat composition comprises between about 0.1 and about 4% (w/w) wax, more preferably between about 0.2 and about 2% (w/w) wax, even more preferably between about 0.25 and about 1.2% (w/w) wax, and most preferably between about 0.4 and about 1% (w/w) wax.

Preferably, the weight ratio of wax to polymer resin in the topcoat composition is at least about 1:1000, preferably at least 5:1000, preferably at least 10:1000, preferably at least 15:1000, preferably at least 17:1000, and more preferably at least 19:1000.

Preferably, the topcoat composition comprises pigment. Where pigment is used, the topcoat composition preferably comprises between about 0.01 and about 2% (w/w) pigment, more preferably between about 0.05 and about 1% (w/w) pigment, even more preferably between about 0.1 and about 0.8% (w/w) pigment, and most preferably between about 0.15 and about 0.6% (w/w) pigment.

Preferably, the weight ratio of the pigment to polymer resin in the topcoat composition is at least about 1:1000, preferably at least 2:1000, preferably at least 3:1000, preferably at least 4:1000, preferably at least 5:1000, and more preferably at least 6:1000. More preferably, the weight ratio of the pigment to polymer resin in the topcoat composition is at least 7:1000, and preferably at least 1:100.

In a preferred embodiment, the composite sheet according to the first aspect may be used in the roofing industry, for forming or repairing roofs or for forming a roof coating.

Accordingly, in a fourth aspect, there is provided a roofing composition comprising the composite sheet according to the first aspect.

By the term “roofing composition”, we mean a composition suitable for forming a roof or roof covering itself, or a composition which may be used to repair or coat an existing roof. The roof may be a flat roof, or a pitched roof, or a corrugated roof.

In use, the composite sheet is applied to a substrate surface, which may be an existing roofing panel. Advantageously, the roofing composition according to the fourth aspect is fire retardant, and is a weather and impact resistant thermosetting structural composite. The composite sheet comprises a UV photoinitiator, which cures the composite sheet (ie “cold curing” even down to temperatures as low as 0° C.), and does not require heat or catalyst to cure. Rain, snow, and frost will not affect the curing reaction provided that sufficient daylight (and therefore UV) has formed at least an outer skin.

The roofing composition is easy to apply to a roof. The composite sheet may be easily cut, formed and applied with basic tools. The composite sheet has a low coefficient of linear expansion, and high tensile strength, and so may be applied without failure or degradation around sharp corners, for example, at the corners of a roof. Once applied, the composite sheet does not lift off due to differing rates of contraction, a problem often suffered by conventional roofing materials.

Preferably, in addition to polymer resin, glass fibre, at least 5% (w/w) metal hydroxide filler, and UV photoinitiator, the composite sheet in the roofing composition comprises a maturation agent.

Optionally, the composite sheet may also comprise one or more additives as described above, e.g., a wetting agent, pigment, and/or styrene. Table 1 shows the most preferred embodiment of the composite sheet (denoted “Composite Mat”) used in the roofing composition according to the invention. It will be appreciated that the ratio of metal hydroxide filler to polymer resin for the composite sheet used in the roofing composition is 1.9:1. Hence, preferably the ratio of metal hydroxide filler to polymer resin is at least 1.5:1, and most preferably at least 1.8:1.

The roofing composition according to the fourth aspect is preferably used in association with an independent primer composition for priming a substrate surface upon which the composite sheet may then be applied. Preferably, the primer composition is applied to the substrate surface, following which the composite sheet is then applied to the primer. The primer seals the substrate and provides a surface to which the composite sheet will bond. Preferably, the primer comprises a polymer resin, and Table 1 shows the most preferred embodiment of the primer when used in the roofing composition. Preferably, the primer comprises UV photoinitiator. A most preferred primer comprises Resin Chrystic PD9635UV.

Once the substrate surface has been covered with primer or “primed”, the composite sheet according to the first aspect is then applied.

The roofing composition is preferably used in association with an independent top-coat composition, which may be applied to the composite sheet. The top-coat composition covers any holes or fissures that may appear in the surface of the composite sheet, thereby making a final waterproofing layer.

Preferably, the top-coat composition comprises polymer resin, at least 5% (w/w) metal hydroxide filler, UV photoinitiator, and glass flakes. Optionally, the top-coat may also comprise one or more additives selected from a maturation agent, wetting agent, pigment, wax, thixotropic agent and/or reactive solvent such as styrene. Table 1 shows the most preferred embodiment of the top-coat used in the roofing composition according to the invention. It will be appreciated that the ratio of metal hydroxide filler to polymer resin for the top-coat of the roofing composition is 1:1. Hence, preferably the ratio of metal hydroxide filler to polymer resin is at least 0.75:1, and most preferably at least 0.9:1.

Preferably, therefore, the roofing composition is a 3-layer system, all the layers of which are preferably UV-curing.

In a fifth aspect, there is provided a method for forming a roof or roof coating, the method comprising the steps of:
(i) contacting a roof or roof substrate with a composite sheet according to the first aspect; and
(ii) exposing the sheet to UV light, whereby the composite sheet becomes rigid to thereby form a roof or a roof coating.

Preferably, the method comprises a preliminary step of applying a suitable primer composition to the roof or roof substrate prior to the composite sheet in step (i). Preferably, the method comprises a further step of applying a topcoat composition to the composite sheet after the composite sheet has been applied to the roof or roof substrate.

In addition to the roofing industry, the composite sheet according to the first aspect may be used in a wide variety of other applications. For example, it may be used anywhere that lead, copper, aluminium, timber or any other conventional material is used, e.g., in civil engineering, buildings and structures. Examples of structures include entire self-supporting structures, such as buildings, bridges, tunnels, masts, water towers, atriums, covered walkways, cladding, shuttering, water diversion and containment, pipes, tubes, tanks, bunds, chemical industry. The composite sheet may be used for carrying potable water, effluent or storm water; in chimney stacks, and linings; in air conditioning ductwork; for corrosion- and fire-resistant cable trays, electrical trunking & ductwork.

The composite sheet according to the invention may be used as a repair system for the construction industry; drainage systems; pipes & pipe jointing; tanks, such as for containing oil, water and chemicals; in flat roofs; or as lead or copper replacement; in damp proofing; for lining floors, walls and ceilings; in food preparation areas and hospitals; in decoration & design; for encapsulating asbestos; for swimming pools; for reservoirs; for lining of silage pits; for building machinery & equipment repairs; in drainage; for lining & repair of tanks; in fencing; for lining trailer floors.

The composite sheet according to the first aspect may also be used in the arts, such as in modelling and sculpture, manufacture of film, theatre & television props and sets, and design prototypes.

The composite sheet according to the first aspect may also be used in the automotive, aviation and marine industries. For example, it is envisaged that the composite sheet may be used for forming body panels, roofs, floor linings and seats; in crash repairs; exhaust emergency repairs; in the forming of aircraft parts, such as fuselage and wings; in boat hull and superstructure making and strengthening; and in repairs and bonding.

The composite sheet of the invention may be used in the waterways industry, e.g., for repairing canals.

The sheet may also be used for making signage (eg road signs); and crash barriers; and for water diversion and storage.

The composite sheet may also be used in do-it-yourself (DIY) applications, in interior and exterior uses around the home and for leisure uses.

It will be appreciated that the specific components and amounts of each component of the composite sheet of the first aspect as described herein will depend on its intended application. For example, the polymer resin may comprise polyesters, vinylester, and/or acrylate. The broad range of composite sheets are preferably fire retardant, weather, and impact resistant thermosetting composites. All embodiments of the composite sheet comprise a UV photoinitiator to cure the polymer resin in a temperature independent manner, i.e., they are all “cold curing”, and so neither heat nor catalyst are absolutely essential for curing. It will be appreciated that the UV photoinitiator is not a catalyst of the polymerization reaction per se. It will be appreciated however that heat and catalyst may improve or increase the rate of curing, once the reaction has been initiated by exposure to UV, for example from sunlight or a UV lamp.

It will be appreciated that the composite sheet may comprise a polymer resin which contains a UV photoinitiator (eg Chrystic 9635UV), and in these embodiments, there is no need to add additional photoinitiator. However, in embodiments where the polymer resin does not contain a photoinitiator (eg a vinylester resin, such as Atalac, or Enova), it is essential to add a UV photoinitiator, for example Chivacure or Trigonal 15.

Table 2 shows one such preferred composition in accordance with the invention. Preferably, in addition to polymer resin, glass fibre, at least 5% (w/w) metal hydroxide filler and UV photoinitiator, the composite sheet also comprises a maturation agent, and optionally, a wetting agent, pigment, and/or styrene. As shown in Table 2, in an embodiment where woven roving is used as the glass fibre, the composite sheet comprises about 24% (w/w) glass fibre. In a corresponding embodiment in which 300 g CSM is used instead of woven roving glass fibre, the fibre glass percentage is approximately 16% (w/w) of the total weight of the composite sheet, with other components scaling proportionately. It will be appreciated that the ratio of metal hydroxide filler to polymer resin for aerospace, marine, chemical and water products is about 1:1. Hence, preferably the ratio of metal hydroxide filler to polymer resin is at least 0.7:1, and most preferably at least 0.9:1.

It is also envisaged that a so-called “two component catalyst system” may be used, for example, as shown in Table 3. Preferably, in addition to polymer resin, glass fibre, at least 5% (w/w) metal hydroxide filler and UV photoinitiator, the composite sheet also comprises a maturation agent, and optionally, a wetting agent, pigment, styrene, and/or an accelerator. This composition includes a photoinitiator called Catalyst Trigonal 15 (which is not as strong a photoinitiator as Chivacure), and so requires a suitable, curing accelerator, such as MDEA.

The compositions shown in Tables 2 and 3 have high concentrations of metal hydroxide filler, glass fibre and vinylester polymer resin, and are particularly useful for aerospace, marine, chemical, food and water applications where strength is important, and water should not be absorbed.

In other preferred embodiments of the invention, the composite sheet may have the composition substantially as set out in Table 4. Such a composition is particularly useful in applications in which the composite sheet is likely to come into contact with water, for example, pools, tanks and aqueducts. It will be appreciated that the ratio of metal hydroxide filler to polymer resin for marine, pools, tanks and aqueducts is 1.4:1. Hence, preferably the ratio of metal hydroxide filler to polymer resin is at least 1:1, and most preferably at least 1.2:1.

In other preferred embodiments of the invention, the composite sheet may have the composition substantially as set out in Tables 5 and 6. Such compositions are particularly useful in fire-retardant applications in which the composite sheet is likely to come into contact with fire, for example rail, oil and gas industries, due to the very high concentrations of metal hydroxide filler. It will be appreciated that the ratio of metal hydroxide filler to polymer resin for fire retardant applications is 3:1. Hence, preferably the ratio of metal hydroxide filler to polymer resin is at least 1:1, more preferably at least 2:1, and most preferably, at least 2.5:1.

In other preferred embodiments of the invention, the composite sheet may have the composition substantially as set out in Tables 7 and 8. Such compositions are particularly useful in fire-retardant applications in which the composite sheet is likely to come into contact with fire, for example rail, oil and gas industries due to the presence of Ceepree and Guardion, which are useful to prevent the spread of fire. It will be appreciated that the ratio of metal hydroxide filler to polymer resin for fire retardant applications is 0.75:1. Hence, preferably the ratio of metal hydroxide filler to polymer resin is at least 0.4:1, more preferably at least 0.5:1, and most preferably, at least 0.6:1.

The invention also provides a novel apparatus for forming a sheet of polymer composite, for example, an ultraviolet light curable polymer resin-impregnated glass fibre composite sheet in accordance with the first aspect.

Hence, according to a sixth aspect of the present invention, there is provided an apparatus for forming a sheet of a polymer composite, the apparatus comprising a fibre substrate feed from which, in use, fibre substrate is supplied to a polymer resin application station, wherein polymer resin is applied to at least one side of the fibre substrate at the polymer resin application station, and a release film is applied to the side of the substrate to which polymer resin is applied, characterised in that the fibre substrate feed supplies the fibre substrate substantially vertically to the polymer resin application station.

The invention further provides a novel method for forming a sheet of polymer composite, for example, an ultraviolet light curable polymer resin-impregnated fibre composite sheet in accordance with the first aspect.

Therefore, according to a seventh aspect of the present invention, there is provided a method of forming a sheet of a polymer composite, the method comprising feeding fibre substrate to a polymer resin application station, applying polymer resin to at least one side of the fibre substrate, and applying a release film to the side of the substrate to which polymer resin is applied, characterised in that the fibre substrate is fed substantially vertically to the polymer resin application station.

Advantageously, it has been found that by feeding the fibre substrate along a substantially vertical path, wrinkling of the finished composite product is significantly reduced.

The fibre substrate feed preferably comprises a feed roller on which fibre substrate is wound. The feed roller may comprise a brake for tensioning the fibre substrate as it feeds to the resin application station. Preferably, the fibre is glass fibre. Suitable glass fibre substrates may be in a sheet form, for example chopped strand mat, or woven roving. Preferably, the glass fibre is in the form of a sheet or mat, such as chopped strand mat, for example glass chopped strand mat 300 g/m².

The fibre substrate feed preferably further comprises a pair of counter-rotating pinch rollers located downstream of the polymer resin application station, the pinch rollers drawing fibre substrate from the feed roller and through the polymer resin application station. Most preferably, the path followed by the fibre substrate, from the feed roller, through the polymer resin application means, to the pinch rollers, is substantially vertical. The pinch rollers are capable of pulling the composite sheet from the feed roller.

The sheet of polymer composite is preferably as described in relation to the first aspect of the present invention. Hence, the polymer resin may, for example, be polymer resin, an epoxy resin, a vinyl ester resin and/or a polyester resin. Preferably, the resin comprises additional components selected from a metal hydroxide filler; a UV photoinitiator; a maturation agent; a pigment; a wetting/dispersing agent; styrene; a curing accelerator; a thixotropic agent; a wax; a fire or flame retardant agent. Each of these components and their concentrations with respect to the resin is described herein with reference to the first aspect, and will not be repeated here.

Preferably, the apparatus comprises at least one take-up roller to which the formed composite sheet is fed.

Preferably, a first release film is applied to one side of the fibre substrate and a second release film to the other side of the substrate, to thereby sandwich the fibre substrate, and polymer resin therebetween. Preferably, therefore, two release film feed rollers are provided, one for each of the first and second release films. Preferably, the release films are dispensed from first and second rollers in such a way that they are fed substantially horizontally from either side of the polymer resin application station and then between the counter-rotating pinch rollers so as to form release films on either side of the composite sheet. The first and/or second rollers may comprise a brake for tensioning the release film as it feeds to the resin application station.

As shown in FIG. 8, the release film comes off its roll substantially vertically, passes over an idle roller which redirects it substantially horizontally, then passes over a crowned roller prior to feeding into the resin application station. The purpose of the crowned roller is to smooth out wrinkles.

Preferably, the apparatus further comprises means for applying an outer cover sheet to one side of the composite, preferably on top of either the first or second release film. Preferably, the outer cover sheet is substantially UV opaque. For example, the cover sheet may be a dark coloured material, or it may be reflective, such as silver leaf or foil. The means for applying an outer cover sheet to one side of the composite may comprise a roller on which UV-opaque material is wound.

The polymer resin application station may comprise rollers which apply the resin to the fibre substrate prior to the composite passing through the counter-rotating rollers. However, preferably the polymer resin application means comprises a container positioned so as to form a layer of polymer resin on an upper surface of the release film. Preferably, the container contains polymer resin, and may be referred to as a “doctor box”. The polymer resin application station is preferably adapted to apply resin to both sides of the fibre substrate. Hence, most preferably the polymer resin application station comprises a second container or “doctor box” positioned so as to form a layer of polymer resin on an upper surface of the second release film. This arrangement has the advantage that movement of the release films towards the fibre substrate before passage between the counter-rotating rollers can cause a wave of polymer matrix or resin to flow towards the substrate and improve impregnation thereof.

A problem that is addressed by preferred embodiments of the apparatus of the invention is the exclusion of air bubbles from the composite sheet that is formed by impregnation of the fibre substrate with polymer resin, as the presence of air bubbles may lead to points of weakness. To achieve this, resin is preferably applied to the fibre substrate predominantly from one side of the substrate. In a preferred arrangement, a weir extends across the container (ie doctor box) on one side of the substrate, with a gap beneath the weir.

By the term “weir”, we mean a barrier capable of controlling the depth of resin on one side of the substrate.

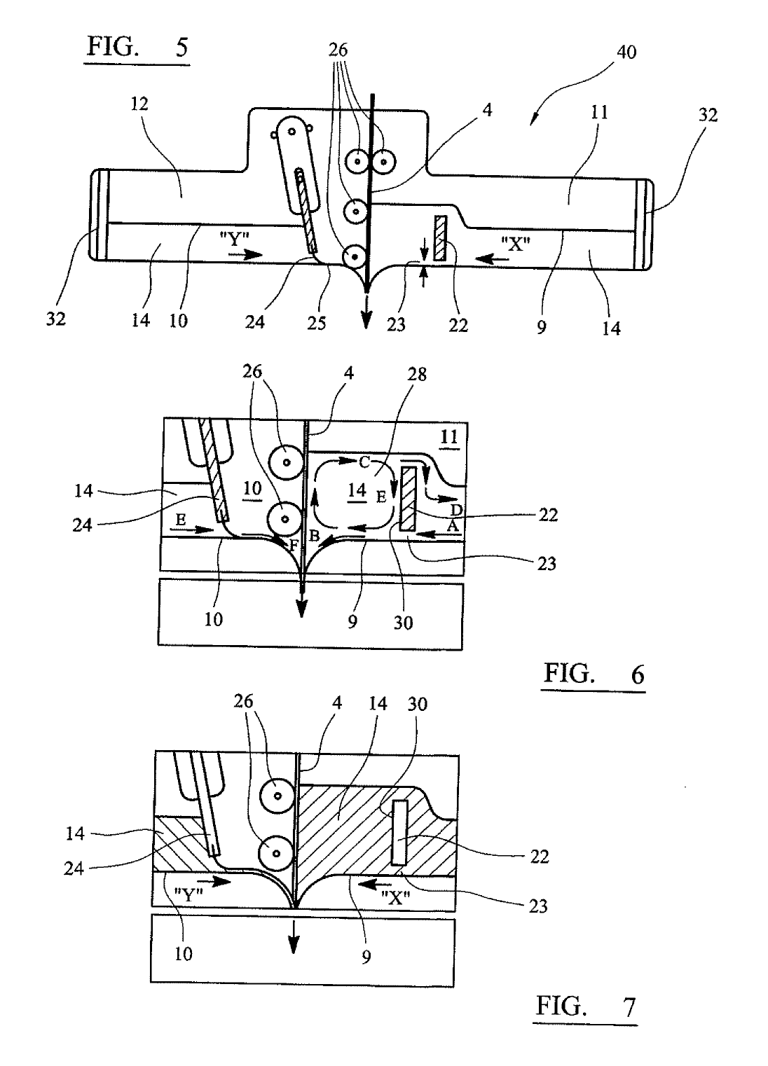

Resin is carried by the release film that passes along the base of the doctor box, through the gap beneath the weir, towards the substrate. If the rate of flow of resin towards the substrate exceeds the rate at which resin enters the substrate, then resin will accumulate in the space between the substrate and the weir and the depth of the resin in that space will increase until excess resin spills back over the top of the weir. The height of the weir therefore controls the depth of the resin, which is typically about 10 cm. The area of contact between the resin and the substrate is thereby increased, and the resin is forced into the substrate, thereby expelling air from the substrate. Appropriate supports, e.g., tubes or rollers, are preferably provided at the reverse side of the substrate to maintain the vertical orientation of the substrate. The use of the weir may also lead to expulsion of air bubbles from within the resin, as described below in relation to FIGS. 5 and 6.

The gap beneath the weir is preferably at least 5 mm, more preferably, at least 7 mm, even more preferably at least 10 mm, more preferably at least 15 mm, and most preferably at least 20 mm. In some embodiments, the gap may even be as much as 25 mm.

At the other side of the substrate, it is preferred that only a thin layer of resin be applied thereto. For example, in some embodiments, a barrier is provided across the doctor box, with a gap being formed between the barrier and the release film. The barrier may be a substrate support, such as a tube or roller. In preferred embodiments, a thin layer is applied to the other side of the substrate by means of a scraper or doctor blade located within the doctor box, typically resiliently-mounted or (at least partly) made of a resilient material. For instance, a scraper blade may have an operative portion that is made of a resilient material, such as silicone rubber. Suitably, the blade is not in contact with the release film, thereby forming a gap therebetween. The distance between the blade and the release film may be adjusted. The distance is preferably less than 3 mm, more preferably less than 2 mm, even more preferably less than 1 mm, and most preferably less than 0.5 mm.

It will be appreciated therefore that the height of resin is significantly higher on one side of the substrate than on the other. In embodiments where the containers on opposite sides of the fibre substrate each contain a barrier to flow of resin, i.e., the weir in one case and a scraper blade in the other, the spaces between the underside of the barrier and the surface side of the corresponding release film are preferably different. Preferably, the difference in gap width underneath the first and second barriers is at least 1 mm, 2 mm, 3 mm, 4 mm, and more preferably at least 5 mm. Preferably, the difference in gap width is at least 6 mm, 7 mm, 8 mm, 9 mm, and more preferably at least 10 mm.

According to another aspect of the invention, there is provided an ultraviolet light curable polymer composite comprising:
i) a matrix containing:
   a) at least one polymer and/or liquid polymer component;
   b) at least one maturation or thixotropic agent;
   c) at least one particulate or powder filler;
   d) at least one ultraviolet photoinitiator;
   e) at least one accelerator; and
ii) glass fibre.

Where the main polymer component is not a resin, the composite may optionally further comprise at least one resin, for example a polymer resin, an epoxy resin, a vinyl ester resin and/or a polyester resin. One preferred resin is unsaturated polyester resin, for example, Synolite® PI7-02. The resin, where provided, is preferably capable of maturation so as to keep the matrix or composite relatively tacky and pliable before exposure to UV light.

Particulates or powder filler may comprise from 0.5% up to 500 phr (parts per hundred of resin), the polymer component may comprise from 5% up to 95% by weight of the composite, the maturation or thixotropic agent from 0.5% to 10% by weight of the composite, the glass fibre reinforcement 0.5% up to 75% by weight of the composite, additives 0.5 to 20% by weight of the composite, and optional foaming agents 0.55% up to 100 phr.

In a further aspect, there is provided an apparatus for forming a sheet of a polymer composite, the apparatus comprising a pair of adjacent substantially parallel rollers configured to rotate in opposed directions, means for feeding a glass fibre substrate having first and second surfaces between the rollers, wherein there is further provided means for applying a liquid polymer matrix onto the first surface of the glass fibre substrate and means for applying a liquid resin to the second surface of the glass fibre substrate prior to its passage between the rollers, and means for feeding first and second release films between the rollers in such a way as to sandwich the fibreglass substrate, polymer matrix and resin therebetween.

According to a further aspect of the present invention, there is provided a method of manufacturing a sheet of a polymer composite, the method comprising applying a liquid polymer matrix to a first surface of a glass fibre substrate, applying a liquid resin to a second surface of the glass fibre substrate opposed to the first, applying a first release film to the first surface of the glass fibre substrate over the liquid polymer matrix, and applying a second release film to the second surface of the glass fibre substrate over the liquid resin.

The glass fibre substrate is preferably dispensed in sheet form from a further roller, and preferably dispensed generally vertically between the counter-rotating rollers. The first and second release films are preferably dispensed from first and second rolls thereof in such a way that they are fed generally horizontally from either side of the pair of counter-rotating rollers and then between the counter-rotating rollers so as to form release films on either side of the composite.

By feeding the glass fibre substrate along a generally vertical path, wrinkling of the finished product is reduced.

A key advantage of applying the liquid polymer matrix from one side only is that it is forced into and through the glass fibre substrate (which may be chopped strand mat or woven roving, for example) from one side, thereby expelling air from the substrate and providing excellent penetration of the matrix into the substrate. Application of the liquid resin from the other side serves to fill in any gaps or air pockets, thereby leading to an improved quality product.

The liquid polymer composite is preferably as described in relation to the first aspect of the present invention, and the liquid resin may, for example, be polymer resin, an epoxy resin, a vinyl ester resin and/or a polyester resin.

The polymer matrix and the resin may be applied by rollers prior to the composite passing through the counter-rotating rollers.

Alternatively, they may be applied by way of doctor boxes positioned so as to form a layer of matrix on an upper surface of the first release film and a layer of resin on the upper surface of the second release film before these contact the glass fibre substrate and pass between the counter-rotating rollers. This has the advantage that movement of the release films towards the glass fibre substrate before passage between the counter-rotating rollers can cause a wave of polymer matrix or resin to flow towards the substrate and to improve coating thereof.

Composites of embodiments of the present invention may be seen as a type of Sheet Moulding Compound (SMC) pre-preg (pre-impregnated glass fibre-resin composite) or Dough Moulding Compound (DMC). Relatively thick release films are preferred when the composite is to be moulded (e.g., formed as an SMC), and thinner films are preferred when the composite is to be draped over an existing structure (e.g., a flat roof or the like).

All of the features described herein (including any accompanying claims, abstract and drawings), and/or all of the steps of any method or process so disclosed, may be combined with any of the above aspects in any combination, except combinations where at least some of such features and/or steps are mutually exclusive.

### EXAMPLES

### Example 1

### UV Curing Compositions

Various polymer matrix compositions may be used in embodiments of the present invention. Some of these are given below:

(i) 300 phr aluminium trihydroxide to 1 phr polymer (comprising >20% methyl methacrylate and <12.5% styrene). The polymer may be Synolite® 5001-T-1.

(ii) 250 phr aluminium trihydroxide, 100 phr intumescent agent (e.g., APP 72 from Chance & Hunt) and 1 phr polymer (comprising >20% methyl methacrylate and <12.5% styrene). The polymer may be Synolite 5001-T-1.

(iii) 100 phr intumescent agent (e.g., Guardion® F6 flame retardant from Chance & Hunt), 1 phr polymer (comprising >20% methyl methacrylate and <12.5% styrene), 100 phr aluminium trihydroxide and 100 phr glass fibre matt. The polymer may be Synolite® 5001-T-1. This composition tends to be intumescent.

(iv) 500 phr intumescent agent (e.g., Guardion® 457X flame retardant from Chance & Hunt), 400 phr polymer (comprising >20% methyl methacrylate and <12.5% styrene), 300 phr aluminium trihydroxide and glass fibre mat. The polymer may be Synolite 5001-T-1.

(v) 400 phr Ceepree® CGB 3BAM fire retardant, 300 phr polymer (comprising >20% methyl methacrylate and <12.5% styrene) and 100 phr glass fibre mat. The polymer may be Synolite 5001-T-1.

(vi) 200 phr parts Ceepree® CGB 3BAM fire retardant,1 phr polymer (comprising >20% methyl methacrylate and <12.5% styrene) and 100 phr glass fibre mat. The polymer may be Synolite 5001-T-1.

All of the above compositions are ultraviolet curable compositions.

### Example 2

### Additional UV Curing Compositions

Further UV-curing composites have the specific compositions set out in Tables 1 to 8.

### Roofing Product

A roofing product, the use of which is described in Example 5, consists of three components, i.e., a primer, a composite glass fibre-resin mat, and a top coat. The composition of each of these components is listed in Table 1.

### Aerospace, Marine, Chemical, Food and Water Products

Two composites have been developed for use in applications where strength is important, and where water is not absorbed. The composition of these composites is shown in Tables 2 and 3.

### Marine, Pools, Tanks and Aqueducts

A composite has been developed for use in any marine application, or in a swimming pool, or in a water or oil tank, or in aqueducts, i.e., where contact with water is expected. The composition of this composite is listed in Table 4. It is described as being a two component catalyst because it includes the photoinitiator, Catalyst Trigonal, and a curing accelerator, MDEA.

### Fire-Retardant Formulations for Rail, Oil and Gas

Two fire-retardant composites have been developed for use in situations where the spread of a fire (should one occur) should be prevented, e.g., in the rail industry (trains, trams, underground etc). The composition of these composites is listed in Tables 5 and 6. The composite in Table 5 is a two component catalyst, and the composite in Table 6 is a one component catalyst because it includes the photoinitiator, Chivacure. Due to the reactivity of Chivacure as a photoinitiator, no accelerator is required.

### Ceepree/Guardion Formulations

Two further fire-retardant composites have been developed for use in situations where fire may be expected, or where the spread of fire should be prevented. The composition of these composites is listed in Tables 7 and 8. The composite in Table 7 is a one component catalyst (Chivacure photoinitiator only), and the composite in Table 8 is a two component catalyst (Catalyst Trigonal 15 and MDEA).

### Example 3

### First Embodiment of the Apparatus

Referring to FIG. 1, there is shown a first embodiment of an apparatus 20 for forming a sheet of polymer composite 16. The apparatus 20 comprises a pair of adjacent substantially parallel “pinch” rollers 1,2 configured to rotate in opposite directions, for example by way of motors or hand cranks. A roll 3 of glass fibre substrate 4 is located above the rollers 1,2. The glass fibre substrate 4 has first 5 and second 6 sides.

The glass fibre substrate 4 is fed between the two rollers 1,2 in a generally vertical orientation. Also provided are two rolls 7,8 of release film 9,10. The release films 9,10 also pass between the two rollers 1,2 so as to sandwich the glass fibre substrate 4 therebetween. A pair of doctor boxes 11,12 are provided above the rollers 1,2, one doctor box 11,12 on each side 5,6 of the glass fibre substrate 4. The doctor boxes 11,12 are loaded with liquid polymer compositions 14 comprising UV-curable polymer resin, metal hydroxide filler and UV photoinitiator (and optionally other components, as described herein). For some applications, however, only one of the doctor boxes 11,12 may be loaded with such a composition, the other doctor box being loaded just with a polymer resin. The upper surface of release film 9 is coated with material from the doctor box 11, and the upper surface of release film 10 with material from the doctor box 12.

Upon passage of the coated release films 9,10 and the glass fibre substrate 4 between the rollers 1,2, liquid polymer composition 14 is forced through the substrate 4 from the first side 5, and any gaps are filled with composition 14 from the second side 6. The layered sheet of polymer composite 16, after passage between the rollers 1,2, is wound into a roll 13 on a take-up roller 15. The parallel rollers 1,2 may also be configured to rotate in opposite directions by running free, or by the release film being pulled through by a motor that drives take-up roller 15.

The polymer composite sheet 16 remains workable until exposed to UV light, whereupon it cures and hardens. Therefore, in order to prevent the composite sheet 16 from curing too soon, the outer surface of the sheet 16 is covered with a removable outer layer 18 which is opaque, at least to UV wavelengths. The outer layer 18 may be applied to the surface of the sheet 16 prior to winding of the sheet 16 onto the take-up roller 15. As an alternative, or in addition, the roll 13 may, after removal from the take-up roller 15, be completely wrapped in UV-opaque material 18 for transport and storage.

In use, in one embodiment, an operator unrolls a length of the sheet 16 from the roll 13, and cuts the sheet 16 to desired shape and size depending on the intended substrate surface, e.g., a roof. Once cut to size, the operator then peels away the opaque outer layer 18, and then both release films 9,10. The composite sheet 16 may then be applied to the substrate surface, and upon exposure to UV (either by sunlight or a UV source), will quickly cure and harden in position.

In use, in another embodiment, the operator first peels the release film 9 and then adheres it to the substrate surface. The operator then sorts out any overlap from an adjacent sheet to be laid thereafter. The composite is then ready to be exposed to UV. The operator may first pull off 18 and then subsequently release film 10 once the composite has formed a skin, or pull off 18 and 10 together. Depending on temperature, there may be a tendency to pull out fibres if 18 and 10 are pulled off together. Further details of the use of the composite sheet 16 are described in Example 5.

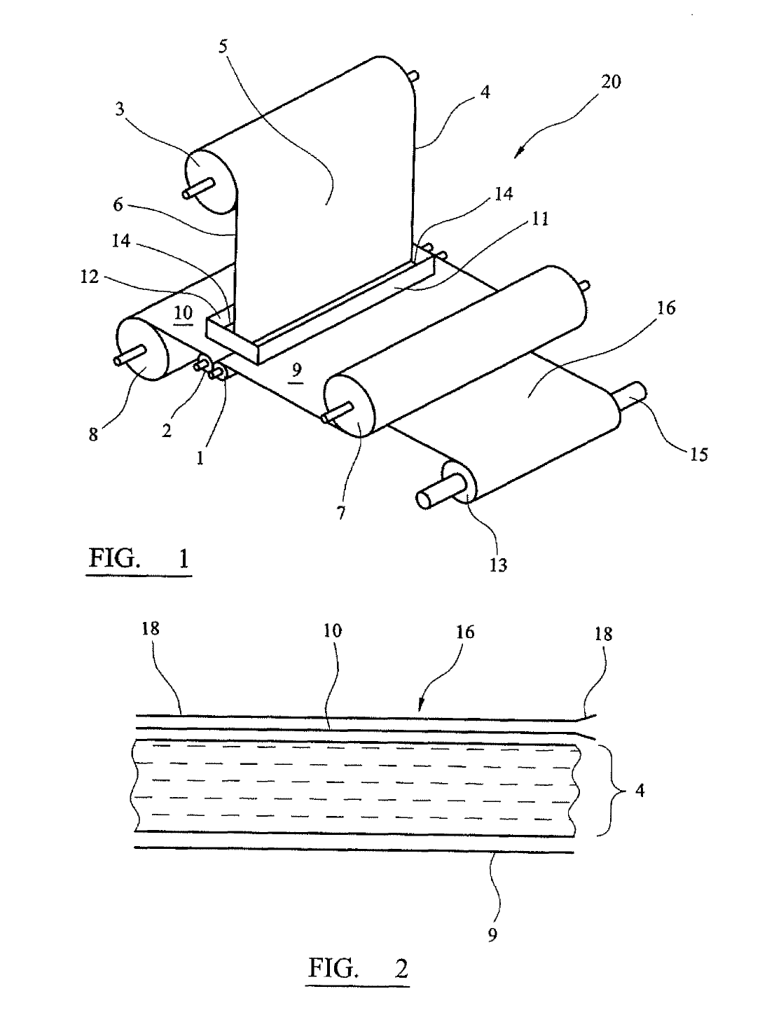

Referring to FIG. 2, there is shown a cross-sectional view of the composite sheet 16. The sheet 16 consists of an inner core of fibre glass substrate 4 which is impregnated with polymer resin 14. The sheet 16 is sandwiched between two layers of release film 9,10, and on the side of the sheet 16 which forms the outermost side of the roll 13, there is provided an opaque outer layer 18 which prevents unwanted curing by UV.

### Example 4

### Second Embodiment of the Apparatus

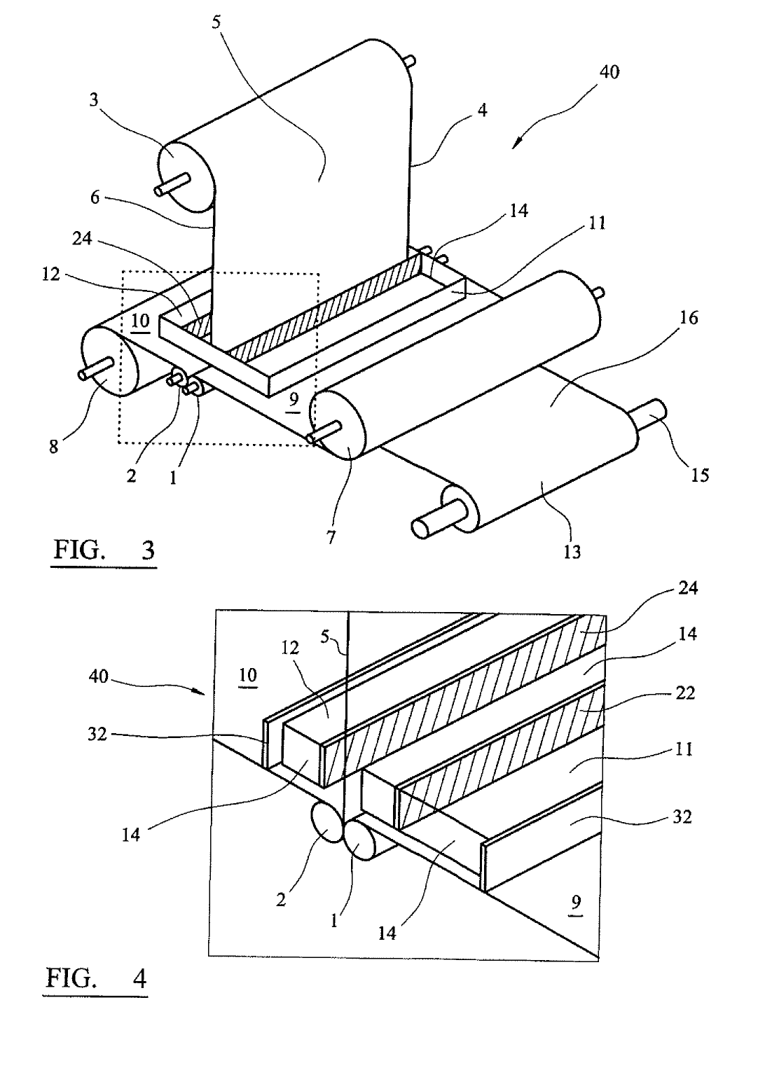

Referring to FIGS. 3 to 8, there are shown various views of a second embodiment 40 of the apparatus for forming the polymer-glass fibre composite sheet 16.

Referring to FIG. 3, the apparatus 40 comprises a pair of adjacent, substantially parallel “pinch” rollers 1,2 configured to rotate in opposite directions, for example by way of motors or hand cranks or running free, or by pulling through of release film 9,10 by a motor driving roll 13. A roll 3 of glass fibre substrate 4 is located above the rollers 1,2. The glass fibre substrate 4 has first 5 and second 6 sides.

The glass fibre substrate 4 is fed downwardly between the two rollers 1,2 in a generally vertical orientation. Also provided are two rolls 7,8 of release film 9,10. The release films 9,10 also pass between the two rollers 1,2 so as to sandwich the glass fibre substrate 4 therebetween. A pair of doctor boxes 11,12 are provided above the points at which the release films 9,10 meet the substrate 4, one doctor box 11,12 on each side 5,6 of the glass fibre substrate 4. Each doctor box 11,12 is essentially a container having side walls 32 into which a liquid polymer composition 14 is loaded, such that the upper surfaces of release films 9,10 are coated with polymer composition 14.

As shown in FIGS. 4 to 7, on one side of the glass fibre substrate 4 (the right hand side in FIG. 5), the doctor box 11 is provided with a strip of metal, which acts as a weir 22 to control the depth of resin 14 that contacts the glass fibre substrate 4. The lower edge of the weir 22 is positioned about 10 mm above the release film 9, thereby leaving a gap 23 through which polymer composition 14 may be drawn by the motion of the release film 9, towards the glass fibre 4 in the direction indicated by arrow “X”.

On the other side of the glass fibre substrate 4 (the left hand side in FIG. 6), the doctor box 12 is provided with a scraper blade 24 which is made of silicone rubber, or mechanically adjusted doctor blade. The blade 24 is resilient and is positioned, at rest, with its lower edge about 0.2 mm above the release film 10, thereby leaving a gap 25 through which polymer composition 14 may be drawn, by the motion of the release film 10, towards the glass fibre 4 in the direction indicated by arrow “Y”.

The object of the process carried out by the apparatus 40 is to apply polymer composition 14 into the glass fibre substrate 4 (mat or web) so as to displace as much as possible of the air entrapped in the glass fibre web 4, as this results in an improved composite 16. Air bubbles provide points of weakness in the composite sheet 16. Prior art composite sheet production processes rely on air bubbles diffusing to the surface before dissipating out of the resin and into the atmosphere. However, for the air bubbles to be sufficiently removed from the polymer resin in a prior art apparatus, it is necessary to have an apparatus which is very long (30 m long or more) in order to give the bubbles time to work their way through and eventually out of the resin. With the apparatus 40 of the present invention, the glass fibre substrate 4 can be impregnated with composition 14 with much reduced or eliminated presence of entrapped air.

As shown in FIG. 6, the scraper blade 24 is fitted about 10 cm from the glass fibre 4, and allows a thin layer of composition 14 to pass thereunder through the approximate and adjustable 0.2 mm gap. Any air bubbles in the composition 14 within doctor box 12 are retained by the scraper blade 24, so that the resin that is carried by the release film 10 beneath the scraper blade 24 into contact with the glass fibre substrate 4 is effectively free of air bubbles. Hence, substantially bubble-free composition 14 impregnates the left hand side of the substrate 4.

On the right hand side of the substrate 4, the weir 22 that is positioned a short distance (about 10 cm) from the glass fibre 4 controls the depth of the polymer composition 14 that is in contact with the glass fibre 4. As indicated by arrow “A”, composition 14 is drawn through the 10 mm gap 23 between the bottom of the weir 22 and the release film 9. The rate at which composition 14 is drawn through the gap 23 exceeds the rate at which the composition 14 impregnates the glass fibre substrate 4, and so the level of the composition in the space 28 between the weir 22 and the substrate 4 increases until it reaches the top of the weir 22, whereupon the composition spills back over the top of the weir 22 (see FIG. 6). The depth of composition 14 in space 28 is about 10 cm. It is believed that the presence of the weir 22 creates a pressure differential within the composition in the space 28, with the composition adjacent the film 9 being at a higher pressure than the composition located above it in the space 28. Any air bubbles present in the composition 14 are therefore caused to migrate upwards, whereupon they either dissipate to the atmosphere above the composition 14 or are transported back over the weir 22 to the right-hand sides (as viewed in the Figures) of the doctor box 11. As indicated by arrow “B”, resin 14 infiltrates into the right hand side of the glass fibre 4 at the lower part of the doctor box 11 where the concentration of air bubbles is less. Resin infiltrates into the right hand side of the glass fibre 4 for the full length of fibre 4 that is in contact with resin 14, i.e., the height of the weir 22. The soaking process is a combination of the time the resin 14 is in contact with the fibre substrate 5, the pressure pushing it through, and the fact that air can escape on the other side, because there is little or no resin 14 on that side for most of the height due to the presence of the scraper or doctor blade 24.

As shown in FIG. 6, the rheology of the composition 14 is such that it circulates upwardly in the space 28 between the weir 22 and glass fibre substrate 4, in an opposite direction to the downward direction of travel of the substrate 4. When the resin 14 reaches the surface, it travels in the direction of arrow “C” towards the weir 22. At least some of the composition 14 may flow back over the top of the weir 22, as indicated by arrow “D”. Hence, excess composition 14 which may have a high concentration of air bubbles flows back over the top of the weir 22.

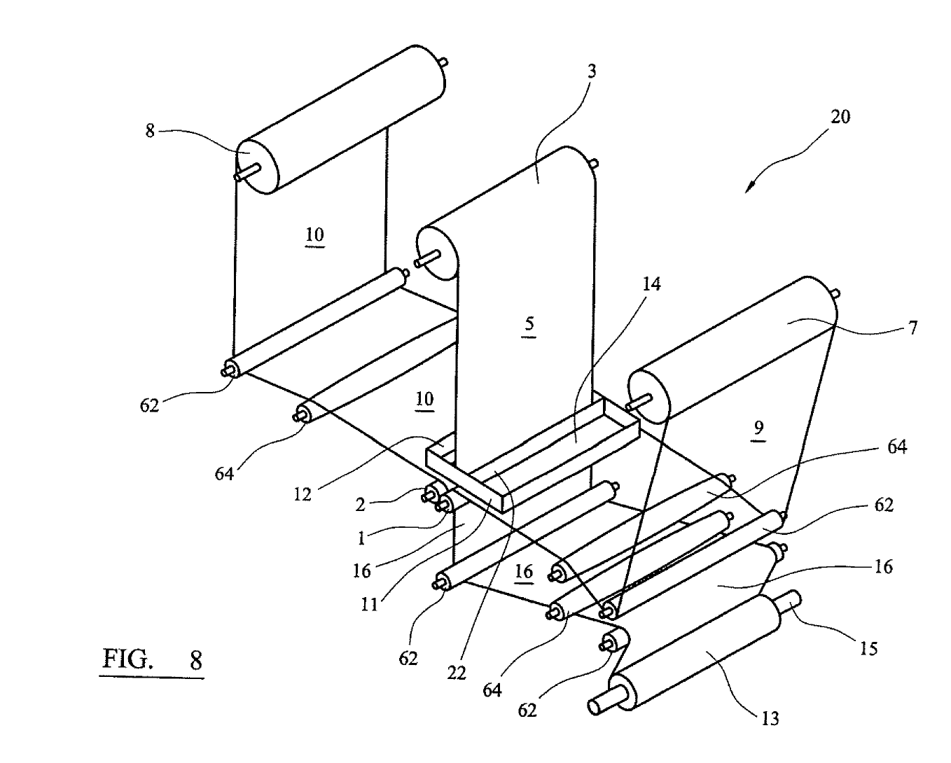

As most clearly evident from FIG. 7, composition 14 is applied to the glass fibre substrate 4 from both sides. However, the different arrangements on the two sides of the glass fibre substrate 4, namely the scraper blade 24 on one side and the weir 22 on the other, result in the composition being applied predominantly from the latter side. The composition 14 is applied under pressure from the right-hand (as viewed in the Figures) side, with the substrate being maintained in a vertical orientation by polished tubes or rollers 26. In the region above the release films 9,10, therefore, composition 14 is applied to the glass fibre substrate 14 from one side only, the composition 14 thereby infiltrating the substrate 14 and forcing air out of the substrate 14. In addition, it is believed that the pressure differential created within the composition 14 in the space 28 results in migration of air bubbles trapped in the composition 14 upwards, and so reduces the extent to which any such air bubbles are introduced into the substrate 4. Likewise, the passage of composition 14 through the narrow gap beneath the scraper blade 24 on the left-hand side of the substrate 4 is believed to eliminate air bubbles from the thin layer of composition 14 applied to the left-hand side of the substrate 14.

The release film 10 is coated, on the left hand side of the substrate 4, with a very thin layer of composition 14. This thin coating does not inhibit the displacement of entrapped air by the composition 14 applied to the other side of the glass fibre 4, and also prevents the build up of excess composition 14 which might otherwise cause collapse the fibre glass 4.

The method exposes the glass fibre 4 to the composition 14 for only a very short time. This reduces or completely eliminates the risk of breakage of the glass fibre 4. Clearly, breaking of the glass fibre 4 would have a deleterious effect on the reinforcing effect of the glass fibre on the matrix that is necessary for a satisfactory end product. The process described herein reduces the time of exposure of the glass fibre 4 to the composition 14 to typically about only 1 second compared to 5 to 30 minutes exposure in prior art methods. Furthermore, the overall length of the apparatus 40 is only about 2.5m compared to 30 m or more for prior art machines. As mentioned above, prior art machines are much longer as they must hold the product for enough time for air bubbles to leave the resin. Hence, the apparatus according to the invention is far more compact.

Once the substrate 4 has been impregnated with composition 14 and sandwiched between release films 9,10 by being fed through the rollers 1,2, the resulting layered sheet of polymer composite is fed to a take-up roller 15 and wound into a roll 13. In currently preferred embodiments, a UV-opaque top sheet 18 is applied to one side of the polymer composite. The means for achieving this is not shown in the Figures, but may involve application of the opaque film to the composite 16 at a point between the pinch rollers 1,2 and the take-up roller 15. The UV-opaque top sheet 18 may also be applied by unrolling 13, applying 18 and re-rolling.

As shown in FIG. 5, the vertical end-walls 32 on the far left and far right of the Figure prevent resin 14 from falling out of each doctor box 11,12. In some embodiments of the apparatus 40, the end walls 32 may be absent.

In other embodiments of the apparatus 40, the scraper blade 24 may also be absent, and instead, a gap between the lowermost roller 26 and the film 10 is used to control the thickness of resin 14 infiltrating into the right hand side of the substrate 4. In use, on the right hand side of the substrate 4, sufficient resin 14 is poured on the release film 9 to the right of the weir 22 to fill up the space 28 and keep it full with resin 14. On the left hand side of the substrate 4, a thin line of resin 14 is poured onto the release film 10 so that there is a build-up behind the lower roller 26. The flow of resin 14 through to the fibre substrate 4 is controlled by the space between roller 26 and the release film 10. If too much resin 14 is administered, the resin 14 flows anticlockwise around roller 26 and falls back behind it.

Referring to FIG. 8, there is shown another view of the second embodiment of the apparatus 60 for forming the polymer-glass fibre composite sheet 16 showing associated rollers 62,64 for tensioning the various components of the composite sheet 16. FIG. 8 illustrates the positioning of an idle roller 62 and a crown roller (or banana bar) 64, which are provided to tension and remove wrinkles from each release film 9,10 prior to them being fed towards the substrate 5. The apparatus also includes an idle roller 62, and a crown roller 64, which are provided to tension and remove wrinkles from the formed composite sheet 16 after it feeds through the pinch rollers 1,2, and before it is rolled on to the roll 13. Finally, brakes (not shown) are provided on the release film rollers 7,8 and the substrate roller 3 in order to control the tension of the release films and substrate.

### Example 5

### A Roofing System

A novel roofing system consists of essentially 3-layers all UV cold-curing, i.e., (i) a primer, (ii) a composite sheet, and (iii) a topcoat. The composition of each component is shown in Table 1.

Use of the roofing system will now be described:

(i) Prepare Substrate Surface

The substrate surface should be structurally sound, clean, dry and free of grease and loose material. All gaps, cracks and lesions should be sealed with all-weather silicone to provide a continuous watertight surface. Sharp protrusions should be covered with patches of composite sheet, if necessary, or ground down, if possible.

(ii) Primer

Primer should be applied thinly all over the substrate including roof edges and upstands. The primer must be slightly tacky when the composite sheet is applied but not wet, therefore it is preferred not to apply an excessive amount at once. If an excessive amount is applied it may be difficult to spread prior to curing resulting in lumps. There are occasions, for example, in lining gutters, where it is possible to apply the composite sheet when the primer is still wet. In such cases, it is important that there is a good source of UV to achieve a cure, e.g., by daylight or a UV light.

The primer may be applied by a squeegee, roller, brush, scraper or sprayed. The primer is also UV curable including resin and UV photoinitiator. A quick cure is important to guarantee a bond to the substrate before the application of the composite sheet because the sheet is coloured and thicker, and will shade the primer and reduce the curing rate. The primer seals the substrate surface, and makes the sticky reinforcing sheet readily bondable.

(iii) Pre-Impregnated Reinforcement Composite Sheet

The sheet must be first measured and then cut with scissors or a craft knife to required lengths. It is important that the edges are covered, if exposed to light more than momentarily. While the primer is still slightly tacky but not wet, the composite sheet is laid thereon, light-protective side up, in position and aligned. When lined up, about 50-100 mm of the clear backing film is then peeled off the underside of the end to be adhered first and tucked underneath. The sheet is then stuck down and smoothed out over the primer.

The sheet is then tensioned from the other end to check alignment and the fixed end can be adjusted if necessary. The sheet is adhered to the roof by pulling the film away on the underside while smoothing the sheeting by brushing the upper surface from side to side. Curing is enabled by pulling the light-protective film (may be white, black, reflective, or silver) away from the clear film. However, the operator must be careful to separate the two top films, only pulling off the light-protective film by holding down the clear film. This ensures that the operator does not pull resin and/or glass-fibre out of the sheet. However under certain conditions it is possible to pull both layers off together without damaging the sheet.

To ensure perfect joins, the operator must place about 10 cm of masking tape or lengths of timber on the seams, and this will stop the cure until they can be attended to. Once the composite sheet has formed a skin (in only a few minutes) the clear film can be removed. Overlapping seams must still be protected from light. If the clear film is left on too long, a gloss finish results. On laying adjacent sheets, the upper sheet is stuck onto the edge previously masked. The best bond is achieved if both surfaces are uncured.

Alternatively one sheet can be laid with the light-proof film. By lifting the transparent film and light-protective film along the edge for 50 mm, the next sheet can be laid with an overlap over the 50 mm ‘laid bare’. The light-protective film (along with the transparent one) can then be folded back and the seam smoothed over/rolled in. The first sheet is then ready to be exposed to the UV to initiate the cure. The light-protective film is pulled off as described holding down the transparent film. Alternatively both films can be pulled off.

The composite sheet must be maturable. It is also capable of consistent maturation (most other resins are not) using Garolite DE Magnesium Oxide Powder. However, Luvatol 35 (a liquid) may be used as a maturation agent. Maturation is a process whereby the polymer resin matrix poise number is kept low (eg about 150) during pouring and wetting the glass fibre mat, rising to 100 fold in as little as 10 minutes. This enables satisfactory flow, wetting out, then the thickening begins to prevent drainage on the roll. However, this has to be very accurately controlled, as there is a trade off. If too much maturation occurs, the material becomes too stiff to unroll and may have a shelf-life of as little as a few hours and very dry to touch. Too little maturation and the polymer matrix drains on the roll during storage and when the release film is peeled off, resin adheres to the film and is wasted and causes voids in the composite. Optimally, when the release film is peeled after a few days, there is very slight resin trace on the film, no drainage whatsoever; and the surface of the composite is sticky. The shelf life is then greater than 3 months.

A preferred composite sheet includes a small amount of resin Palapreg 17-02 which to some degree dilutes PD9635UV resin as it is a poor maturation resin, and not very consistent. It has been found that with this addition of Palapreg 17-02, the long term shelf life and surface stickiness is maintained. It also slows down the cure a little, because it is a low reactivity resin whereas the Euro resins Palapreg 15.02, Chrystic PD9635UV and PD9958UV have very high curing rates.

The high concentrations of the metal hydroxide filler (ie ATH 904) used enable a far better quality product during manufacture, as its greater overall density and pack density forces air quickly out of the glass fibres as the process demands. ATH 904 is a very highly refined ATH, which allows a greater pack density, giving a low coefficient of thermal expansion, more resistance to crack propagation, resistance to thermal cracking, very low moisture ingress, very good impact strength and resistance to foot traffic. The greater density of metal hydroxide filler greatly reduces the resin content giving a colder cure so that differences in thermal expansion on radii and sharp corners is not a problem. Accordingly, the roofing system can be effectively used around sharp corners without cracking. ATH 904 is relatively low in cost, and hence the greater pack density cuts costs. Furthermore, ATH 904 mixes well with the resin, reducing ‘white spots’ (areas of undissolved powder) and subsequent weakening of the product. Furthermore, ATH reduces curling and lift-off of the composite sheet from the substrate surface.

Prior art UV curing systems have had to use either little or no colouring (ie pigments) due to the UV blocking effect of the colour paste. In contrast, the UV curing system according to the present invention may comprise a pigment (about 1-0.5% per resin). However, the concentration is reduced in the composite sheet as a fast cure is required. Pigment may be applied to the topcoat as a base or backing colour.

Chrystic PD9635UV (Pre-Catalysed) Resin is preferred because it has the ability to take far stronger colouring than other systems tried, up to a factor of 10. Surprisingly, this reduced the watery colours attainable previously. It is believed that the reason it is possible to put more colour paste (pigment) in the composite is the strong catalyst system used.

Styrene is included to make the polymeric matrix mix and flow in the apparatus 40 easier. It can be present at a level of from 0 to 10% (w/w).

Byk 996 is a wetting and dispersing additive, which allows the resin to coat the ATH and glass fibres better.

CSM (Chopped Strand Mat) glass fibre is used as an important part of the manufacturing process as it would not be possible for sprayed (Deposited) fibre to travel between the pinch rollers as the fibres would bunch up. CSM eliminates most ‘deposit’ errors as it is made on a large scale and more controlled.

(iv) Topcoat

The topcoat coating contains additional glass flakes and covers any pinholes that may appear in the surface of the reinforcement, making a final waterproofing layer. It is important that the composite sheeting must be thoroughly cured prior to applying the topcoat. This may require about 15 minutes on a sunny day and 4 hours on an overcast day from the time the black light-protective film is removed. Curing time can be assessed by cutting a small sample, removing the release film, folding it double, removing the light-protective film from one side and exposing it to daylight by placing it, (remaining) light-protective side down, the roof. The reason it is folded double is to mimic overlaps. It is important that the underside is cured, which may be judged by scratching it after removing the black light-protective and clear film. If no material comes away, it is cured.

Before topcoat application, one must check all the joins. Edges can be sealed by brushing additional primer at 900 into the joins, removing any excess. The topcoat composition must be stirred in the shade thoroughly prior to use. The composite sheet must then be coated with topcoat, at approximately 0.75 kg/m² with a squeegee, brush or roller. The tin must be covered between dipping the roller. The squeegee, brush or roller must also be covered when not in use with black polythene. The application of topcoat should be complete at least 2 hours before dusk. Edges must be screwed horizontally and edge trims should be bonded to the roof.

On uncured composite sheet, where a bend in the sheeting is required, it is good practice to use all-weather silicone or transparent tape to hold it in place while curing. All-weather silicone will provide an edge seal Examples would be outer edges, vertical edges, on brickwork, around pipes, brackets etc. This procedure will also prevent the composite sheet from lifting off at drip edges prior to curing.

The roofing system in accordance with the invention provides an effective, and easy to use system for repairing roof coverings. To date, no other UV curable pre-impregnated sheets of polymer resin-fibre glass suitable for a roofing system are on the market.

### Example 6

### Further Applications

Other embodiments of the composite sheet (shown in Tables 2-8) may be used in a wide variety of applications, as described herein.

TABLE 1
Roofing Product

| | | | % of total | % of total |
|---|---|---|---|---|
| | Ingredient | Possible substitutes | resin | mass |
| Composite Mat | Resin Chrystic PD9635UV | Other UV curing resins eg. PD9958UV | 80% | 22.44% |
| | Resin Palapreg 17-02 | Other low activity resins | 20% | 5.61% |
| | ONO 904 ATH | other ATH | 190% | 53.29% |
| | Colour Paste - Lewellyn Ryland | other polyester colour pastes | 0.60% | 0.17% |
| | Styrene | | 4.50% | 1.26% |
| | Byk 996 Wetting and dispersing | Other agents such as BYK-W 9010, 990, 995 | 4% | 1.07% |
| | additive | | | |
| | Garolite DE Magnesium oxide | Luvatol or other MgO | 0.60% | 0.17% |
| | Glass CSM 300 Grms mtr sq | Other mass CSM, Woven roving, other bound | | 16% |
| | | glass fibre matting | | |
| | | | 300% | 100.00% |
| Primer | Resin Chrystic PD9635UV | Other UV curing resins | 100% | 100% |
| TopCoat | Resin Chrystic PD9635UV | Other UV curing resins | 100% | 44.73% |
| | ONO 904 ATH | other ATH | 100% | 44.73% |
| | Colour Paste - Lewellyn Ryland | other polyester colour pastes | 1.00% | 0.45% |
| | Styrene | | 4.00% | 1.79% |
| | Byk 996 | Other agents such as BYK-W 9010, 990, 995 | 1.00% | 0.45% |
| | Byk 410 Thixotropic agent | Other Thixotropes | 0.56% | 0.25% |
| | MW Wax additive | Other non-wetting agents such as Byk S-780 | 2.00% | 0.89% |
| | Flake glass 600N | Other glass flakes of similar size such as 750 | 15.00% | 6.71% |
| | | Unmilled from Glasflake | | |

TABLE 2
Aerospace, Marine, Chemical, Food, & Water Products (Applications
where strength is important and water is not absorbed)

| | | % of | % of |
|---|---|---|---|
| Ingredient | Possible substitutes | total resin | total mass |
| Vinylester resin - Atalac | other vinylester resins | 100% | 36.92% |
| Enova, 590, 382 | | | |
| ONO 921 ATH | other ATH | 100% | 36.92% |
| Byk 996 | Other agents such as | 2% | 0.74% |
| | BYK-W 9010, 990, | | |
| | 995 | | |
| Styrene | | 3% | 1.11% |
| Chivacure | Other one component | 0.25% | 0.09% |
| | photoinitiators | | |
| Garolite DE | Luvatol or other MgO | 0.60% | 0.22% |
| Woven roving glass | Other grades of fibre | | 24% |
| | reinforcement matting | | |
| | | 206% | 1 |

When 300 g CSM is used Instead of Woven Roving the glass percentage is approx 16% with other components scaling proportionately

TABLE 3
Aerospace, Marine, Chemical, Food, & Water Products (Applications
where strength is important and water is not absorbed)

| | | % of | % of |
|---|---|---|---|
| Ingredient | Possible substitutes | total resin | total mass |
| Vinylester resin - Atalac | other vinylester resins | 100% | 36.26% |
| Enova, 590, 382 | | | |
| ONO 921 ATH | other ATH | 100% | 36.26% |
| Byk 996 | Other agents such as | 2% | 0.73% |
| | BYK-W 9010, 990, | | |
| | 995 | | |
| Styrene | | 3% | 1.09% |
| Catalyst Trigonal 15 | | 2% | 0.73% |
| MDEA accelerator | Other two component | 2.00% | 0.73% |
| | catalyst and | | |
| | accelerators | | |
| Garolite DE | Luvatol or other MgO | 0.60% | 0.22% |
| Woven roving glass | Other grades of fibre | | 24% |
| | reinforcement matting | | |
| | | 210% | 100% |

When 300 g CSM is used instead of Woven Roving the glass percentage is approx 16% with other components scaling proportionately

TABLE 4
Marine, Pools, Tanks, Aqueducts

| | | | |
|---|---|---|---|
| | | % of total | % of total |
| Ingredient | Possible substitutes | resin | mass |

Resin pre-catalysed

The same formulation as roofing with or without colour paste Different mass CSM such as 450 g,
600 g or 900 g can be used with proportionate increase in the mass of the glass fibre

| | | | | |
|---|---|---|---|---|
| Two component catalyst | Resin Palapreg 17-02 | Other low activity resins | 100% | 32.36% |
| | ONO 904 ATH | other ATH | 140% | 45.31% |
| | Colour Paste - Lewellyn Ryland - | other polyester colour pastes | 0.60% | 0.19% |
| | or none | | | |
| | Styrene | | 3.00% | 0.97% |
| | Byk 996 Wetting and dispersing | Other agents such as BYK-W | 2.1% | 0.68% |
| | additive | 9010, 990, 995 | | |
| | Garolite DE Magnesium | Luvatol or other MgO | 0.60% | 0.19% |
| | Catalyst Trigonal | | 2.00% | 0.65% |
| | MDEA Accelerator | | 2.00% | 0.65% |
| | Glass CSM 300 Grms mtr sq | Other mass CSM, Woven roving, | | 19% |
| | | other | | |
| | | bound glass fibre matting | | |
| | | | 250% | 100.00% |

Different mass CSM such as 450 g, 600 g or 900 g can be used with proportionate increase in the mass of the glass fibre

TABLE 5
Fire-retardant Formulations for Rail, Oil & Gas

| | | % of | % of |
|---|---|---|---|
| Ingredient | Possible substitutes | total resin | total mass |
| Resin Euro 5001 | | 100% | 18.60% |
| ONO 921 | other ATH | 300% | 55.81% |
| Byk 995 | Other agents such as | 4.5% | 0.84% |
| | BYK-W 9010, 990, 996 | | |
| Catalyst Trigonal 15 | | 2% | 0.37% |
| MDEA accelerator | Other two component | 2% | 0.37% |
| | catalyst and accelerators | | |
| Woven roving glass | Other glass reinforcement | | 24% |
| | | 409% | 100% |

When 300 g CSM is used instead of Woven roving the % glass reduces to approx 16% - other components adjust proportionately

TABLE 6
Fire-retardant Formulations for Rail, Oil & Gas

| | | Possible | % of total | % of total |
|---|---|---|---|---|
| | Ingredient | substitutes | resin | mass |
| One | Resin Euro | | 100% | 18.78% |
| component | 5001 | | | |
| catalyst | ONO 921 | other ATH | 300% | 56.33% |
| | Byk 995 | Other agents such | 4.5% | 0.84% |
| | | as BYK-W | | |
| | | 9010, 990, 996 | | |
| | Chivacure | | 0.25% | 0.05% |
| | Woven roving | Other glass | | 24% |
| | glass | reinforcement | | |
| | | | 405% | 100% |

When 300 g CSM is used instead of Woven roving the % glass reduces to approx 16% - other components adjust proportionately

TABLE 7
Ceepree/Guardion formulations

| | | Possible | % of total | % of total |
|---|---|---|---|---|
| | Ingredient | substitutes | resin | mass |
| One | Resin Euro | | 100% | 19.16% |
| component | 5001 | | | |
| catalyst | ONO 921 | other ATH | 75% | 14.37% |
| | Byk 995 | Other agents such | 1.5% | 0.29% |
| | | as BYK-W | | |
| | | 9010, 990, 996 | | |
| | Ceepree CH2 | | 95% | 18.20% |
| | Guardion 457X | Other two | 125% | 23.94% |
| | | component | | |
| | | catalyst and | | |
| | | accelerators | | |
| | Chivacure | | 0.25% | 0.05% |
| | Woven roving | Other glass | | 24% |
| | glass | reinforcement | | |
| | | | 397% | 100% |

When 300 g CSM is used instead of Woven roving the % glass reduces to approx 16% - other components adjust proportionately

TABLE 8
Ceepree/Guardion formulations

| | | | % of | |
|---|---|---|---|---|
| | | Possible | total | % of total |
| | Ingredient | substitutes | resin | mass |
| Two | Resin Euro 5001 | | 100% | 18.98% |
| component | ONO 921 | other ATH | 75% | 14.23% |
| catalyst | Byk 995 | Other agents such | 1.5% | 0.28% |
| | | as BYK-W | | |
| | | 9010, 990, 996 | | |
| | Ceepree CH2 | | 95% | 18.03% |
| | Guardion 457X | Other two | 125% | 23.72% |
| | | component | | |
| | | catalyst | | |
| | | and accelerators | | |
| | Catalyst | | 2.00% | 0.38% |
| | Trigonal 15 | | | |
| | MDEA | | 2.00% | 0.38% |
| | accelerator | | | |
| | Woven roving | Other glass | | 24% |
| | glass | reinforcement | | |
| | | | 401% | 100% |

When 300 g CSM is used instead of Woven roving the % glass reduces to approx 16% - other components adjust proportionately

What is claimed is:

1. An ultraviolet light-curable polymer resin-impregnated fibre composite sheet comprising:
(i) UV-curable polymer resin;
(ii) fibre;
(iii) at least 5% (w/w) metal hydroxide filler; and
(iv) at least one UV photoinitiator,
wherein the composite sheet becomes rigid upon exposure to UV light.

2. A composite sheet according to claim 1, wherein the composite sheet comprises at least 20% (w/w) filler.

3. A composite sheet according to claim 1, wherein the metal hydroxide comprises a suitable Group 3 metal hydroxide.

4. A composite sheet according to claim 1, wherein the polymer resin comprises an ester resin, vinyl ester resin or a polyester resin.

5. A composite sheet according to claim 1, wherein the fibre comprises glass fibre.

6. A composite sheet according to claim 1, wherein the composite sheet comprises between about 0.05 and about 2% (w/w) maturation agent, which is capable of increasing the viscosity of the composition.

7. A composite sheet according to claim 1, wherein the maturation agent comprises elemental magnesium or magnesium oxide (MgO).

8. A composite sheet according to claim 1, wherein the composite sheet comprises between about 1 and about 60% (w/w) fire or flame retardant agent.

9. A composite sheet according to claim 1, wherein the uncured composite is sandwiched between two release films, and comprises at least one outer layer which is substantially opaque to UV light.

10. A method of forming a UV-cured article, the method comprising the steps of:
(i) exposing a composite sheet according to claim 1 to UV light; and
(ii) allowing the composite sheet to become rigid to thereby form a UV cured article.

11. A method according to claim 10, wherein the method comprises an initial step, before step (i), of contacting the composite sheet with a suitable substrate surface on which the sheet is cured with UV light to form the UV-cured article, wherein the substrate surface is the surface of a mould or any surface which requires the application of the composite sheet thereto.

12. A method according to claim 10, wherein a primer composition is initially applied to the substrate surface before application of the composite sheet, which primer composition is chemically compatible with the composite sheet to be applied thereto.

13. A method according to claim 10, wherein the composite sheet is used in combination with a topcoat composition, which topcoat composition comprises a UV-curable polymer resin; at least 5% (w/w) metal hydroxide filler; and at least one UV photoinitiator, and becomes rigid upon exposure to UV light.

14. A roofing composition comprising the composite sheet according to claim 1.

15. The roofing composition according to claim 14, in association with an independent primer composition for priming a substrate surface upon which the composite sheet is to be applied.

16. The roofing composition according to claim 14, in association with an independent top-coat composition, which may be applied to the composite sheet.

17. A method for forming a roof or roof coating, the method comprising the steps of:
(i) contacting a roof or roof substrate with a composite sheet according to claim 1; and
(ii) exposing the sheet to UV light, whereby the composite sheet becomes rigid to thereby form a roof or a roof coating.

18. A method according to claim 17, wherein the method comprises a preliminary step of applying a suitable primer composition to the roof or roof substrate prior to the composite sheet in step (i).

19. A method according to claim 17, wherein the method comprises a further step of applying a topcoat composition to the composite sheet after the composite sheet has been applied to the roof or roof substrate.

20. An apparatus for forming a sheet of a polymer composite, the apparatus comprising a fibre substrate feed from which, in use, fibre substrate is supplied to a polymer resin application station, wherein polymer resin is applied to at least one side of the fibre substrate at the polymer resin application station, and a release film is applied to the side of the substrate to which polymer resin is applied, characterised in that the fibre substrate feed supplies the fibre substrate substantially vertically to the polymer resin application station.

21. An apparatus according to claim 20, wherein the apparatus comprises means for applying a first release film to one side of the fibre substrate and a second release film to the other side of the substrate, to thereby sandwich the fibre substrate and polymer resin therebetween.

22. An apparatus according to claim 20, wherein the apparatus further comprises means for applying an outer UV opaque cover sheet to one side of the composite, on top of either the first or second release film.

23. An apparatus according to claim 20, wherein the polymer resin application station comprises a container positioned so as to form a layer of polymer resin on an upper surface of the release film, wherein a weir extends across the container, with a gap beneath the weir through which resin carried by the release film passes towards the substrate.

24. An apparatus according to claim 20, wherein the polymer resin application station is adapted to apply resin to both sides of the fibre substrate.

25. An apparatus according to claim 24, wherein the polymer resin application station comprises a second container positioned so as to form a layer of polymer resin on an upper surface of the second release film, wherein a barrier is provided across the second container, with a gap being formed between the barrier and the release film through which polymer resin may pass leading to the substrate.
